(19) United States
(12) Patent Application Publication
(10) Pub. No.: US 2026/0228445 A1
(43) Pub. Date: Aug. 6, 2026

(54) CONVERSATION SYSTEM, CONVERSATION CONTROL METHOD, AND STORAGE MEDIUM

(71) Applicants: Masaki NOSE, Kanagawa (JP); Yuuto GOTOH, Kanagawa (JP); Chihiro ASADA, Tokyo (JP)

(72) Inventors: Masaki NOSE, Kanagawa (JP); Yuuto GOTOH, Kanagawa (JP); Chihiro ASADA, Tokyo (JP)

(21) Appl. No.: 19/150,225

(22) PCT Filed: Jan. 18, 2024
(86) PCT No.: PCT/IB2024/050473

§ 371 Date: Jul. 23, 2025

(30) Foreign Application Priority Data
Feb. 7, 2023 (JP) 2023-017067
Dec. 27, 2023 (JP) 2023-221852

(51) Int. Cl. G06F 40/35

(52) U.S. Cl. CPC G06F 40/35

(57) ABSTRACT

A conversation system performs a conversation with a user using a conversation agent. The conversation system includes a first acquisition unit, a second acquisition unit, a generation unit, and a control unit. The first acquisition unit acquires language information of the user from the conversation. The second acquisition unit acquires non-language information of the user from the conversation. The generation unit generates response content including a verbal response and a non-verbal response of the conversation agent. The verbal response is based on the language information of the user and the non-verbal response is based on the non-language information of the user. The control unit controls the conversation agent based on the response content generated by the generation unit.

### TECHNICAL FIELD

Embodiments of the present disclosure relate to a conversation system, a conversation control method, and a storage medium.

### BACKGROUND ART

Conversation systems are known to include a conversation agent that automatically responds to a message from a user. Agent systems are known to learn a conversation with a user and changes an attribute such as an appearance or a personality of the conversation agent (e.g., Patent Literature (PTL) 1).

### CITATION LIST

### Patent Literature

### [PTL 1]

Japanese Unexamined Patent Application Publication No. 2022-093479

### SUMMARY OF INVENTION

### Technical Problem

In the related art, a conversation agent cannot generate the response content in a conversation with a user, based on language information and non-language information of the user.

In light of the above-described problem, an embodiment of the present disclosure allows a conversation system that perform a conversation with a user using a conversation agent to generate the response content of the conversation agent based on the language information and non-language information of the user.

### Solution to Problem

In order to solve the problem described above, a conversation system according to an embodiment of the present disclosure is a conversation system that performs a conversation with a user using a conversation agent. The conversation system includes a first acquisition unit, a second acquisition unit, a generation unit, and a control unit. The first acquisition unit acquires language information of the user from the conversation. The second acquisition unit acquires non-language information of the user from the conversation. The generation unit generates response content including a verbal response and a non-verbal response of the conversation agent based on the language information of the user and the non-language information of the user. The control unit controls the conversation agent based on the response content generated by the generation unit.

### Advantageous Effects of Invention

According to an embodiment of the present disclosure, in a conversation system that performs a conversation with a user using a conversation agent, the conversation system can generate the response content of the conversation agent based on language information of the user and non-language information of the user.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a diagram illustrating a system configuration of a conversation system according to an embodiment of the present disclosure.

FIG. 2 is a diagram illustrating a conversation agent according to an embodiment of the present disclosure.

FIG. 3 is a diagram illustrating another conversation agent according to an embodiment of the present disclosure.

FIG. 4 is a diagram illustrating an overview of conversation processing according to an embodiment of the present disclosure.

FIG. 5 is a diagram illustrating a hardware configuration of a computer according to an embodiment of the present disclosure.

FIG. 6 is a diagram illustrating a hardware configuration of a terminal device according to an embodiment of the present disclosure.

FIG. 7 is a diagram illustrating a functional configuration of a conversation system according to an embodiment of the present disclosure.

FIG. 8 is a flowchart of conversation processing according to an embodiment of the present disclosure.

FIG. 9 is a diagram illustrating a functional configuration of a generation unit according to a first embodiment of the present disclosure.

FIG. 10AA and 10AB are flowcharts of conversation processing according to the first embodiment of the present disclosure, and FIG. 10BA and 10BB are another flowcharts of the conversation processing according to the first embodiment of the present disclosure.

FIG. 11 is a diagram illustrating a use of non-language information according to the first embodiment of the present disclosure.

FIG. 12 is a diagram illustrating a transition of a conversation scenario according to a second embodiment of the present disclosure.

FIG. 13 is another diagram illustrating the transition of the conversation scenario according to the second embodiment of the present disclosure.

FIG. 14 is a diagram illustrating a conversation screen according to a third embodiment of the present disclosure.

FIG. 15 is a diagram illustrating a functional configuration of a conversation system according to the third embodiment of the present disclosure.

FIG. 16 is a flowchart of conversation processing according to the third embodiment of the present disclosure.

FIG. 17 is a diagram illustrating a functional configuration of a conversation system according to a fourth embodiment of the present disclosure.

FIG. 18

FIGS. 18A and 18B are diagrams illustrating a conversation log according to the fourth embodiment of the present disclosure.

FIG. 19 is a diagram illustrating a functional configuration of a conversation system according to a fifth embodiment of the present disclosure.

FIG. 20 is a flowchart of sales copy presentation processing according to the fifth embodiment of the present disclosure.

FIG. 21 is a diagram illustrating a functional configuration of a conversation system according to a sixth embodiment of the present disclosure.

FIG. 22 is a diagram illustrating input-output information according to the sixth embodiment of the present disclosure.

FIG. 23 is a flowchart of conversation processing according to the sixth embodiment of the present disclosure.

FIG. 24 is a diagram illustrating a system configuration of a usage scene 1 according to an embodiment of the present disclosure.

FIG. 25 is a flowchart of conversation start processing of the usage scene 1 according to an embodiment of the present disclosure.

FIG. 26 is a diagram illustrating a system configuration of a usage scene 2 according to an embodiment of the present disclosure.

FIG. 27 is a flowchart of conversation start processing of the usage scene 2 according to an embodiment of the present disclosure.

FIG. 28 is a diagram illustrating a system configuration of a usage scene 3 according to an embodiment of the present disclosure.

FIG. 29 is a flowchart of a conversation start processing of a usage scene 3 according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise.

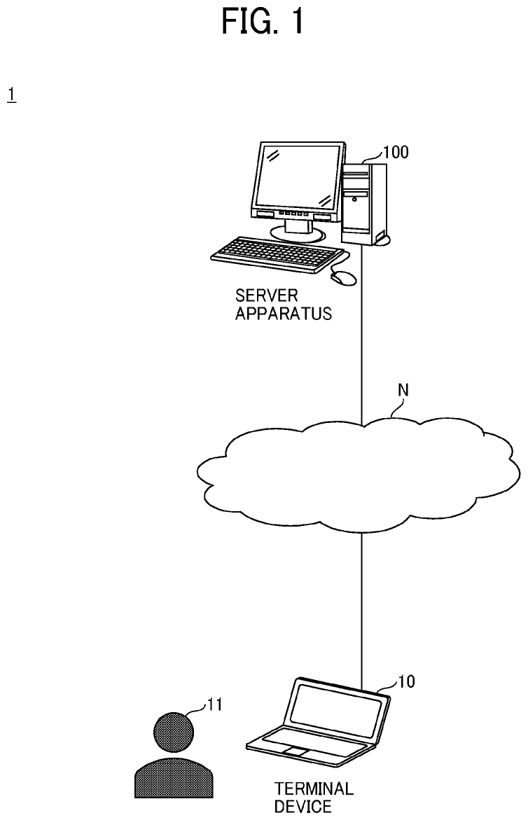

A description is given below of several embodiments of the present disclosure with reference to the drawings. FIG. 1 is a diagram illustrating a system configuration of a conversation system 1 according to an embodiment of the present disclosure. In FIG. 1, the conversation system 1 includes, for example, a server apparatus 100 and a terminal device 10 that are connected to a communication network N such as the Internet or a local area network (LAN).

The server apparatus 100 is, for example, an information processing apparatus having a configuration of a computer or a system including multiple computers. The server apparatus 100 causes a computer included in the server apparatus 100 to execute a predetermined program in order to provide a conversation service in which a conversation agent automatically responds to a message from a user 11 who uses the terminal device 10.

The terminal device 10 is, for example, an information terminal used by the user 11, such as a personal computer (PC), a tablet terminal, or a smartphone. The terminal device 10 can communicate with the server apparatus 100 via the communication network N. The user 11 can use the terminal device 10 to use the conversation service provided by the server apparatus 100.

Preferably, the conversation system 1 performs a conversation in which the conversation agent automatically responds to a message from a user to support the performance of a predetermined task such as a business negotiation or nursing care.

The system configuration of the conversation system 1 illustrated in FIG. 1 is an example.

The terminal device 10 is not limited to a general-purpose information terminal, and may be, for example, a dedicated terminal device or various electronic devices. The conversation system 1 may be implemented by, for example, one information processing apparatus having a computer configuration. In the following description, it is assumed that the conversation system 1 has a system configuration as illustrated in FIG. 1.

The conversation agent is a system that uses knowledge including registered information and knowledge, or an artificial intelligence (AI) to automatically respond to a question from a user or a customer.

As a use case, the conversation agent may be used as, for example, a web conference, a web site, a smartphone application program, or a peopleless AI avatar in a metaverse space.

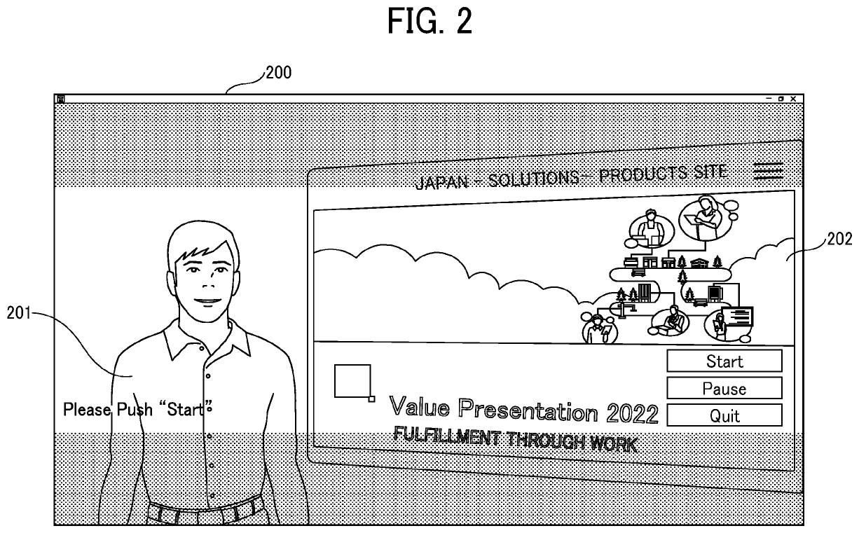

FIG. 2 is a diagram illustrating an image of the conversation agent according to an embodiment of the present disclosure. FIG. 2 illustrates an example of a conversation screen 200 for a business negotiation. The server apparatus 100 causes the terminal device 10 to display the conversation screen 200. In the example of FIG. 2, a virtual human 201 generated by three dimensional (3D) modeling is displayed on the conversation screen 200. The virtual human 201 serves as a conversation agent. The server apparatus 100 controls, for example, the virtual human 201 to proceed with the business negotiation while having a conversation with the user 11 on the conversation screen 200.

As a preferred example, a large display 202 is displayed on the conversation screen 200 for the business negotiation in FIG. 2. The server apparatus 100 can also control the display 202, for example, to display products and services proposed to the user and cause the virtual human 201 to explain products and services.

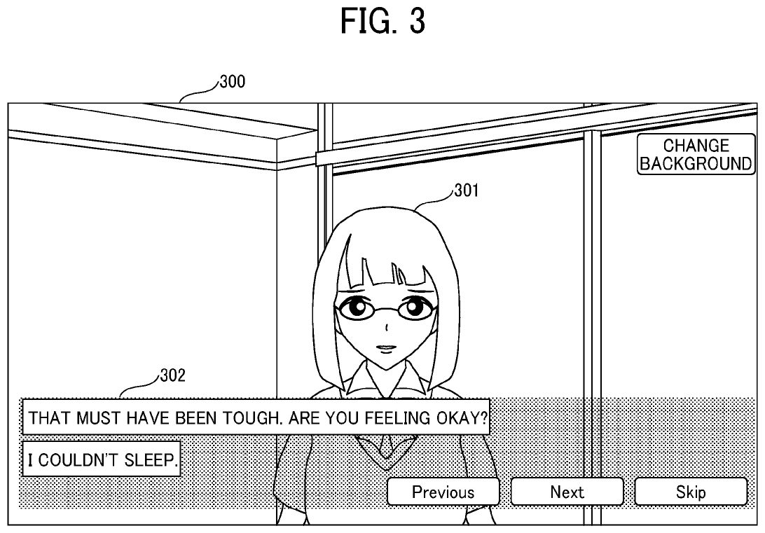

FIG. 3 is a diagram illustrating another image of the conversation agent according to an embodiment of the present disclosure. FIG. 3 illustrates an example of a conversation screen 300 for a nursing care use. The server apparatus 100 causes the terminal device 10 to display the conversation screen 300. As similar to FIG. 2 described above, another virtual human 301 generated by 3D modeling is displayed on the conversation screen 300 as an example in FIG. 3. The virtual human 301 serves as another conversation agent. The server apparatus 100 controls the virtual human 301, for example, so that an elderly person living alone perform communication in the conversation screen 300 to prevent dementia.

As a preferred example, the conversation between the user 11 and the virtual human 301 can be performed by character strings as a conversation 302 illustrated in FIG. 3 in addition to (or instead of) sound.

As described above, the conversation system 1 can change a conversation scenario to change conversation content in accordance with various purposes such as business negotiation, nursing care, class, or counseling.

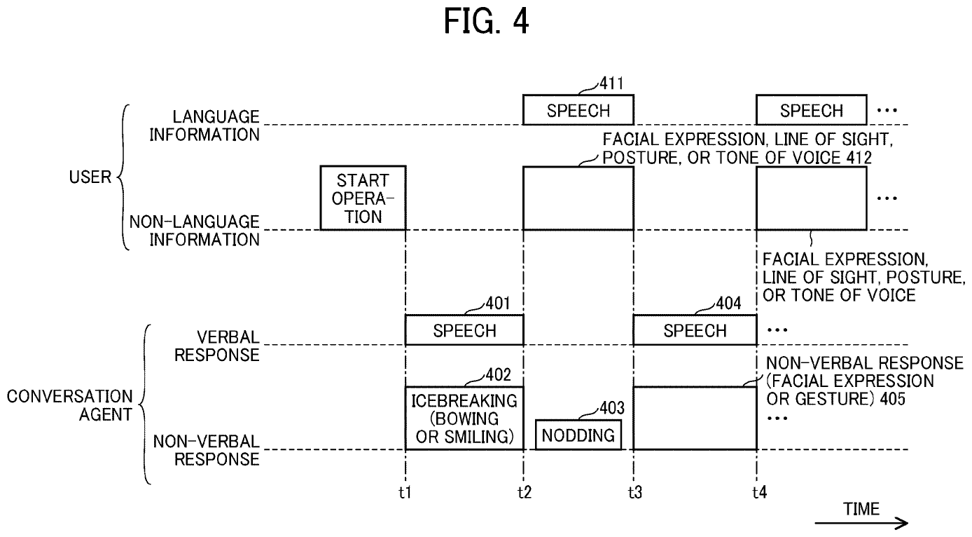

FIG. 4 is a diagram illustrating an overview of conversation processing according to an embodiment of the present disclosure. FIG. 4 illustrates an example of the relation between language information and non-language information of the user 11 and a verbal response and a non-verbal response of the conversation agent in the conversation between the user 11 and the conversation agent, with the horizontal axis representing time.

In FIG. 4, when the user 11 performs a start operation, the server apparatus 100 causes the conversation agent to perform a speech 401 such as greeting or icebreaking as a verbal response at time t1. The server apparatus 100 also causes the conversation agent to perform an icebreaking 402 such as bowing or smiling as a non-verbal response at the time t1.

When the user 11 performs speech at time t2 in response to the performance of the conversation agent, the server apparatus 100 acquires the language information of the user 11 and the non-language information of the user 11. At this time, the server apparatus 100 may cause the conversation agent to perform, for example, a non-verbal response such as nodding 403.

The language information of the user 11 includes, for example, information indicating the content of the speech 411 of the user 11, which is converted into text data by the speech recognition technology. The non-language information of the user 11 includes information other than the language information, such as a facial expression, line of sight, posture, or emotion of the user 11, which is acquired by the image recognition technology. The non-language information of the user 11 may further include, for example, sound information (paralanguage) other than language, such as a tone of voice, a speaking speed, a pitch of voice, strength of voice, coughing, sighing, laughing, or silence, which is acquired from the sound included in a video of the user 11. As described above, non-language information such as an image and a sound is utilized in a multimodal manner.

The language information is information in which the content of speech is transmitted through words. For example, information that is transmitted in a meaning based on well-defined language rules and dictionaries, such as words, grammars, sentence structures, and contexts. The language information includes, for example, information indicating the content of the speech 411 of the user 11, which is converted into text data by the speech recognition technology.

The non-language information is information transmitted through other than words. The non-language information includes information other than the language information, such as a facial expression, line of sight, posture, or emotion of the user 11, which is acquired by the image recognition technology. The non-language information of the user 11 further include, for example, sound information (paralanguage) other than language, such as a tone of voice, a speaking speed, a pitch of voice, strength of voice, coughing, sighing, laughing, or silence, which is acquired from the sound included in a video of the user 11. As described above, the conversation system 1 according to the present embodiment utilizes non-language information such as an image and a sound in a multimodal manner.

The server apparatus 100 interprets an intention of the speech of the user 11 based on the language information of the user 11 and in consideration of the non-language information of the user 11. Accordingly, the server apparatus 100 can enhance the accuracy of interpretation of the intention compared to when the intention is interpreted based on the language information alone.

The server apparatus 100 further generates the response content of the conversation agent corresponding to the intention of the speech of the user 11. The response content includes a verbal response representing the speech content spoken by the conversation agent and a non-verbal response representing, for example, a facial expression or a gesture of the conversation agent. Preferably, the server apparatus 100 changes the non-verbal response of the conversation agent in accordance with the acquired non-language information of the user 11.

At time t3, the server apparatus 100 controls the conversation agent in accordance with the generated response content. For example, the server apparatus 100 executes synthesis speech processing to convert the generated verbal response into sound and causes the conversation agent to speech a speech 404. Preferably, the server apparatus 100 moves the mouth of the conversation agent in accordance with the speech 404 of the conversation agent (lip synchronization). The server apparatus 100 causes the conversation agent to execute the non-verbal response, for example, such as a facial expression or a gesture in accordance with the generated non-verbal response.

As described above, the conversation system 1 according to the present embodiment changes the response content (the verbal response and the non-verbal response) of the conversation agent (the virtual human 201 or the virtual human 301) according to the non-language information of the user 11. The conversation system 1 according to the present embodiment performs a conversation with the user 11 using the conversation agent. As a result, the conversation system 1 can perform a more appropriate reaction with respect to the user 11.

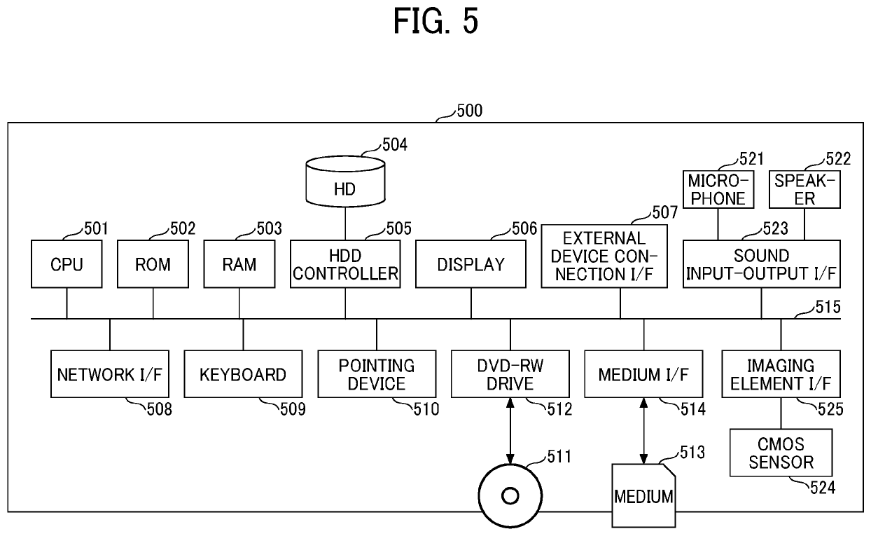

The server apparatus 100 includes, for example, a hardware configuration of a computer 500 illustrated in FIG. 5. Alternatively, the server apparatus 100 is configured by the multiple computers 500. The terminal device 10 may include, for example, the hardware configuration of the computer 500 illustrated in FIG. 5.

FIG. 5 is a diagram illustrating the hardware configuration of the computer 500 according to an embodiment of the present disclosure. As illustrated in FIG. 5, the computer 500 includes, for example, a central processing unit (CPU) 501, a read-only memory (ROM) 502, a random-access memory (RAM) 503, a hard disk drive (HDD) 504, a HDD controller 505, a display 506, an external device connection interface (I/F) 507, a network I/F 508, a keyboard 509, a pointing device 510, a digital versatile disk rewritable (DVD-RW) drive 512, a medium I/F 514, and a bus line 515.

When the computer 500 is the terminal device 10, the computer 500 further includes a microphone 521, a speaker 522, a sound input-output I/F 523, a complementary metal oxide semiconductor (CMOS) sensor 524, and an imaging element I/F 525.

The CPU 501 controls overall operation of the computer 500. The ROM 502 stores programs such as an initial program loader (IPL) to boot the computer 500. The RAM 503 is used as, for example, a work area for the CPU 501. The HDD 504 stores, for example, programs such as an operating system (OS), application programs, and device drivers, and various data. The HDD controller 505 controls, for example, reading or writing of various data to and from the HDD 504 under the control of the CPU 501. The HDD 504 and the HDD controller 505 are examples of storage devices.

The display 506 displays, for example, various information such as a cursor, a menu, a window, a character, or an image. The display 506 may be external to the computer 500. The external device connection I/F 507 is an interface for connecting various external devices to the computer 500. The network I/F 508 is an interface for connecting the computer 500 to the communication network 2 and communicating with other devices.

The keyboard 509 serves as an input device provided with multiple keys that allow a user to input, for example, characters, numerals, or various instructions. The pointing device 510 serves as an input device that allows the user to, for example, select or execute a specific instruction, select an item to be processed, or move the cursor being displayed. The keyboard 509 and the pointing device 510 may be external to the computer 500.

The DVD-RW drive 512 controls the reading and writing of various data from and to a DVD-RW 511, which is an example as a removable storage medium. The DVD-RW 511 is not limited to the DVD-RW, and other recording media, which can be attached to and detached from the DVD-RW drive 512, may be used instead of the DVD-RW. The medium I/F 514 controls reading and writing (storing) of data from and to a storage medium 513 such as a flash memory. The bus line 515 includes an address bus, a data bus, and various control signals. The bus line 515 electrically connects the above-described hardware components to each other.

The microphone 521 is a built-in circuit that converts sound into an electrical signal. The speaker 522 is a built-in circuit that generates sound such as music or voice by converting an electrical signal into physical vibration. The sound input-output I/F 523 is a circuit for inputting or outputting a sound signal between the microphone 521 and the speaker 522 under the control of the CPU 501.

The CMOS sensor 524 serves as a built-in imaging device that captures an object (e.g., a self-portrait photograph) under the control of the CPU 501 to obtain image data. The computer 500 may include an imaging device such as a charge coupled device (CCD) sensor instead of the CMOS sensor 524. The imaging element I/F 525 is a circuit that controls the driving of the CMOS sensor 524.

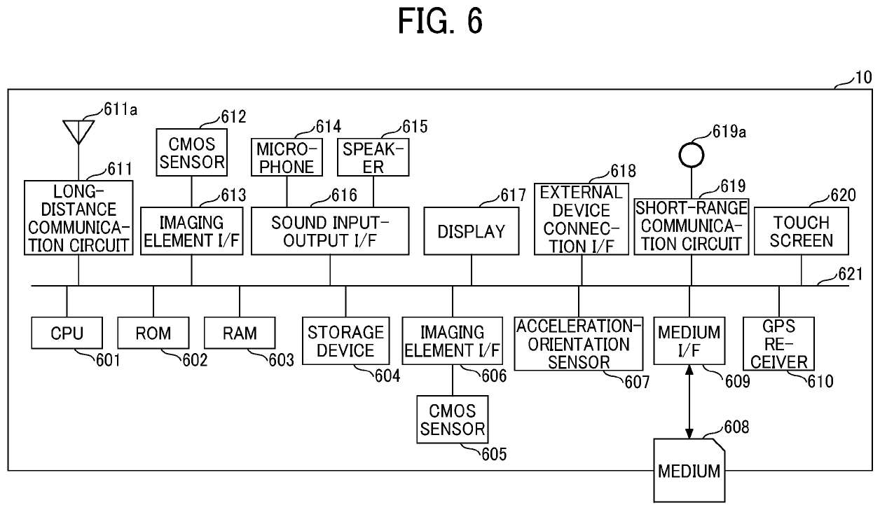

FIG. 6 is a diagram illustrating a hardware configuration of the terminal device 10 according to an embodiment of the present disclosure. The hardware configuration of the terminal device 10 in a case where the terminal device 10 is an information terminal such as a smartphone or a tablet terminal is described below.

In FIG. 6, the terminal device 10 includes a CPU 601, a ROM 602, and a RAM 603, a storage device 604, a CMOS sensor 605, an imaging element I/F 606, an acceleration-direction sensor 607, a medium I/F 609, and a global positioning system (GPS) receiver 610.

The CPU 601 executes predetermined programs to control the overall operations of the terminal device 10. The ROM 602 stores, for example, programs such as an initial program loader used for booting the terminal device 10. The RAM 603 is used as a work area for the CPU 601. The storage device 604 is a large-capacity storage device that stores the OS, programs such as application programs, and various types of data, and is implemented by, for example, a solid-state drive (SSD) or a flash ROM.

The CMOS sensor 605 serves as a built-in imaging device that captures an object (typically, a self-portrait photograph) under the control of the CPU 601 to obtain image data. The terminal device 10 may include an imaging device such as a CCD sensor instead of the CMOS sensor 605. The imaging element I/F 606 is a circuit that controls the driving of the CMOS sensor 605. The acceleration-direction sensor 607 includes an electromagnetic compass or gyrocompass for detecting geomagnetism and an acceleration sensor. The medium I/F 609 controls reading and writing (storing) of data from and to a storage medium 608 such as a flash memory (storage medium). The GPS receiver 610 receives a GPS signal (positioning signal) from a GPS satellite.

The terminal device 10 further includes a long-range communication circuit 611, an antenna 611a for the long-range communication circuit 611, a CMOS sensor 612, an imaging element I/F 613, a microphone 614, a speaker 615, a sound input-output I/F 616, a display 617, an external device connection I/F 618, a short-range communication circuit 619, an antenna 619a for the short-range communication circuit 619, and a touch panel 620.

The long-range communication circuit 611 is a circuit that enables the terminal device 10 to communicate with other devices through the communication network 2. The CMOS sensor 612 serves as a built-in imaging device that captures an object under the control of the CPU 601 to obtain image data. The imaging element I/F 613 is a circuit that controls the driving of the CMOS sensor 612. The microphone 614 is a built-in circuit that converts sound into an electrical signal. The speaker 615 is a built-in circuit that generates sound such as music or voice by converting an electrical signal into physical vibration. The sound input-output I/F 616 is a circuit for inputting or outputting a sound signal between the microphone 614 and the speaker 615 under the control of the CPU 601.

The display 617 serves as a display unit that displays an image of the object and various icons. The display 617 includes a liquid crystal display (LCD) and an organic electroluminescence (EL) display. The external device connection I/F 618 is an interface that connects the terminal device 10 to various external devices. The short-range communication circuit 619 includes a circuit that performs short-range wireless communication. The touch panel 620 is an input device that allows a user to touch a screen of the display 617 to operate the terminal device 10.

The terminal device 10 further includes a bus line 621. The bus line 621 includes an address bus and a data bus, which electrically connects the components illustrated in FIG. 6 such as the CPU 601.

The hardware configuration of the terminal device 10 illustrated in FIG. 6 is an example. The terminal device 10 may have other various hardware configurations as long as the terminal device 10 has a configuration of a computer, a communication circuit, a display, a microphone, and a speaker.

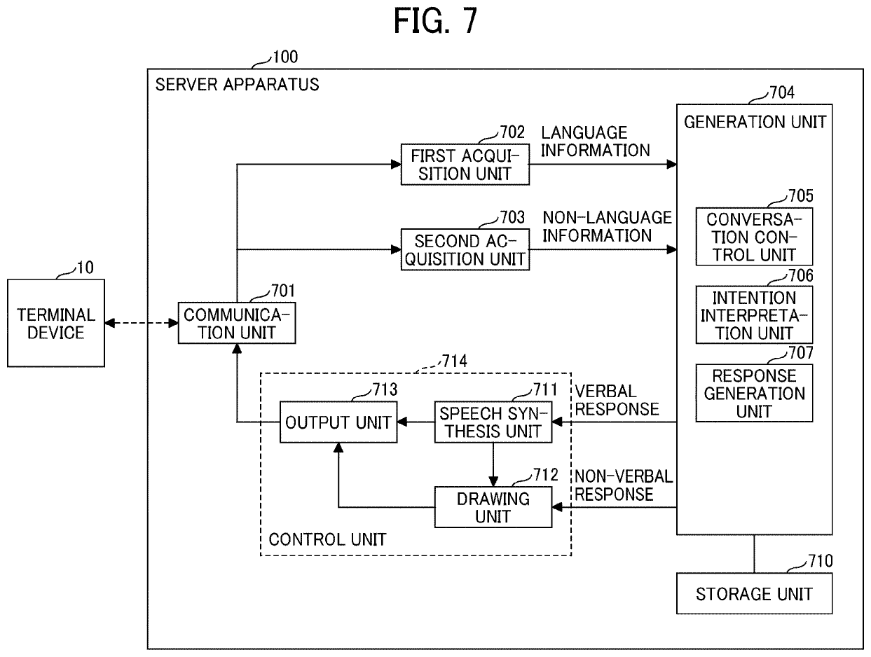

FIG. 7 is a diagram illustrating a functional configuration of the conversation system 1 according to an embodiment of the present disclosure.

The server apparatus 100 causes the computer 500 included in the server apparatus 100 to execute predetermined programs stored in a storage medium to implement, for example, the functional configuration as illustrated in FIG. 7. As illustrated in FIG. 7, the server apparatus 100 includes a communication unit 701, a first acquisition unit 702, a second acquisition unit 703, a generation unit 704, a speech synthesis unit 711, a drawing unit 712, and an output unit 713. At least a part of the functional units described above may be implemented by hardware.

In the server apparatus 100, a storage unit 710 is implemented by a storage device such as the HDD 504 and the HDD controller 505. The storage unit 710 may be implemented by, for example, a storage server provided outside the server apparatus 100 or a cloud service.

The communication unit 701 connects the server apparatus 100 to the communication network N using, for example, the network I/F 508, and executes communication processing to communicate with other apparatuses such as the terminal device 10.

The first acquisition unit 702 executes first acquisition processing to acquire language information of the user 11 from a conversation with the user 11 who uses the terminal device 10. For example, the first acquisition unit 702 detects a speech segment from the video (moving image and sound) of the user 11 received by the communication unit 701 from the terminal device 10 by a technology such as voice activity detection (VAD) and acquires a speech sound of the user 11. The first acquisition unit 702 executes speech recognition processing on the acquired speech sound of the user 11 to convert the speech sound of the user 11 into text data. After that, the first acquisition unit 702 acquires the text data of the speech sound of the user 11 converted into text data as the language information of the user 11.

The second acquisition unit 703 executes second acquisition processing to acquire the non-language information of the user 11 from a conversation with the user 11 who uses the terminal device 10. For example, the second acquisition unit 703 executes image processing to acquire the non-language information of the user 11, such as a facial expression, line of sight, or emotion, from the video (moving image and sound) of the user 11 received by the communication unit 701 from the terminal device 10. The second acquisition unit 703 acquires the non-language information of the user 11, such as volume of the voice, intonation of the voice, or tone of the voice, from the video (moving image and sound) of the user 11 received by the communication unit 701 from the terminal device 10.

The generation unit 704 executes generation processing to generate the response content including a verbal response (conversation content) and a non-verbal response (operation or paralanguage of the conversation agent) of the conversation agent, based on the language information of the user 11 acquired by the first acquisition unit 702 and the non-language information of the user 11 acquired by the second acquisition unit 703. For example, the generation unit 704 includes a conversation control unit 705, an intention interpretation unit 706, and a response generation unit 707. The backend of the response generation unit 707 stores a large amount of conversation information (sound and image) that is actually performed, and the conversation information is used for the construction of the response generation unit 707. When the response generation unit 707 employs a machine learning model described below, the conversation information is used as learning data, which contributes to enhance the accuracy of conversation generation.

The conversation control unit 705 executes conversation control processing. The conversation control processing includes the processing for inputting the language information and the non-language information of the user 11 and the processing for outputting the verbal response and the non-verbal response of the conversation agent.

The intention interpretation unit 706 executes intention interpretation processing to interpret the intention of the speech of the user 11 based on the language information of the user 11 in consideration of the non-language information of the user 11. For example, when the user 11 speaks “That is OK”, it may be difficult to determine whether the user 11 intends to be “good” or “unnecessary” with the language information (text data of speech sound) alone of the user 11. The intention interpretation unit 706 according to the present embodiment interprets the intention of the speech of the user 11 using not only the language information (text data of the speech sound) of the user 11 but also the non-language information of the user 11. As a result, the intention interpretation unit 706 can enhance the accuracy of the intention interpretation processing.

For example, the intention interpretation unit 706 may input the language information and the non-language information of the user 11 to a machine learning model in order to interpret the intention of the speech of the user 11. The machine learning model is pre-trained by inputting the language information and the non-language information of multiple users to interpret the intention of the user 11.

In the present disclosure, the machine learning is defined as a technology that makes a computer acquire human-like learning ability. In addition, the machine learning refers to a technology in which a computer autonomously generates an algorithm required for determination such as data identification from learning data loaded in advance and applies the generated algorithm to new data to make a prediction. Any suitable learning method is applied for machine learning, for example, any one of supervised learning, unsupervised learning, semi-supervised learning, reinforcement learning, and deep learning, or a combination of two or more those learning.

The response generation unit 707 executes response generation processing to generate the response content of the conversation agent corresponding to the intention of the speech of the user 11. The response content includes a verbal response representing the speech content spoken by the conversation agent and a non-verbal response representing, for example, a facial expression or a gesture of the conversation agent. Preferably, the server apparatus 100 changes the verbal response and the non-verbal response of the conversation agent in accordance with the acquired non-language information of the user 11.

For example, the response generation unit 707 changes the content of the action of the conversation agent in accordance with the non-language information of the user 11. The response generation unit 707 changes the timing of the action of the conversation agent in accordance with the non-language information of the user 11.

When the response generation unit 707 generates the response content, the response generation unit 707 can use, for example, natural language processing based on a rule base or a large-scale language model. As an example of the large-scale language model, a sentence generation language model called generative pre-trained transformer 3 (GPT-3 ) can be applied. In the rule-based natural language processing, the response content of the conversation agent is generated based on a rule in which the response content is described in advance with respect to the intention of the speech of the user.

The progress of the response content includes a scenario type and a slot filling type.

The speech synthesis unit 711 executes synthesis speech processing to convert the verbal response generated by the generation unit 704 into speech by a speech synthesis technique.

The drawing unit 712 executes drawing processing to draw a conversation screen on which a conversation agent is drawn, in accordance with the non-verbal response generated by the generation unit 704. For example, the drawing unit 712 reflects a facial expression, line of sight, posture, or emotion on the virtual human (conversation agent) 201 as illustrated in FIG. 2 in accordance with the non-verbal response.

Preferably, the drawing unit 712 also draws a lip synchronization that moves the mouth of the conversation agent in accordance with the speech of the conversation agent.

The output unit 713 executes output processing to output a video including the sound of the conversation agent converted into sound by the speech synthesis unit 711 and the conversation screen drawn by the drawing unit 712. For example, the output unit 713 transmits a video including the sound of the conversation agent converted into sound by the speech synthesis unit 711 and the conversation screen drawn by the drawing unit 712 to the terminal device 10 via the communication unit 701.

The speech synthesis unit 711, the drawing unit 712, and the output unit 713 serve as a control unit 714 that controls the conversation agent based on the response content generated by the generation unit 704.

The storage unit 710 stores various information such as a machine learning model, a rule, setting information, and a conversation log used by the server apparatus 100, data, and programs.

The terminal device 10 may have any functional configuration as long as the terminal device 10 can access the server apparatus 100 using, for example, a web browser included in the terminal device 10, display the conversation screen 200 as illustrated in FIG. 2, and transmit the video of the user 11.

The system configuration of the conversation system 1 illustrated in FIG. 7 is merely an example. For example, the conversation system 1 may be configured by one information processing apparatus having the functional configuration of the server apparatus 100 illustrated in FIG. 7. The terminal device 10 may include at least part of the functional units of the server apparatus 100. For example, the terminal device 10 may include the first acquisition unit 702, the second acquisition unit 703, the speech synthesis unit 711, the drawing unit 712, and the output unit 713. In this case, the terminal device 10 may transmit the language information and the non-language information to the server apparatus 100. After that, the terminal device 10 may display the conversation screen based on the verbal response and the non-verbal response received from the server apparatus 100.

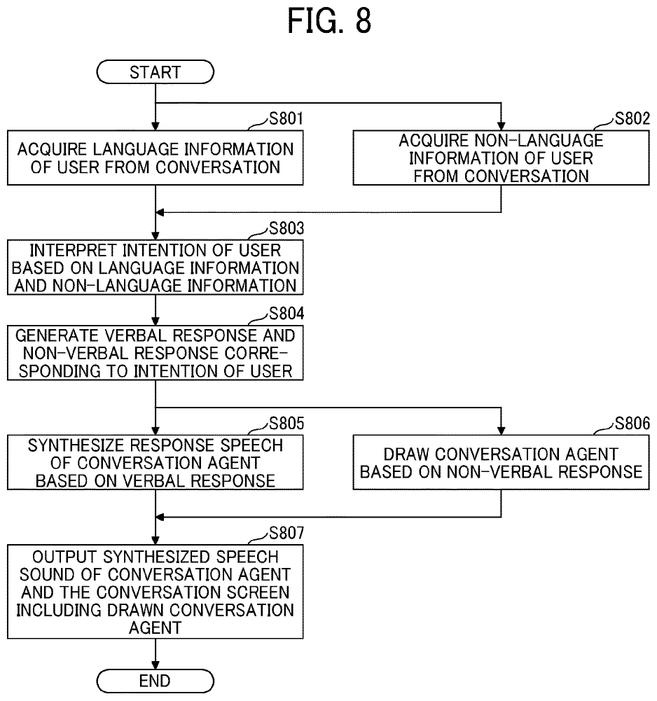

FIG. 8 is a flowchart of the conversation processing that the conversation system 1 executes, according to an embodiment of the present disclosure. The conversation processing is an example of the processing repeatedly executed by the conversation system 1 having the functional configuration as illustrated in FIG. 7. It is assumed that a conversation has already been performed between the user 11 who uses the terminal device 10 and the conversation agent provided by the server apparatus 100 at the start of the processing of FIG. 8.

In step S801, the first acquisition unit 702 acquires the language information of the user 11 from the conversation between the user 11 and the conversation agent. For example, the first acquisition unit 702 acquires the speech sound of the user 11 from the video of the user 11 received by the communication unit 701 from the terminal device 10. The first acquisition unit 702 also executes the speech recognition processing on the acquired speech sound of the user 11 to acquire the text data (language information) to which the speech sound of the user 11 has been converted.

In step S802, the second acquisition unit 703 acquires the non-language information of the user 11 from the conversation between the user 11 and the conversation agent in parallel with the processing of step S801. For example, the second acquisition unit 703 executes the image processing on the video of the user 11 received by the communication unit 701 from the terminal device 10 to acquire the non-language information such as a facial expression, line of sight, or emotion of the user 11. The second acquisition unit 703 executes speech processing on the video of the user 11 received by the communication unit 701 from the terminal device 10 to acquire the non-language information such as volume of voice, intonation of voice, or the tone of voice.

In step S803, the generation unit 704 interprets the intention of the speech of the user 11 based on the language information of the user 11 acquired by the first acquisition unit 702 and the non-language information of the user 11 acquired by the second acquisition unit 703.

In step S804, the generation unit 704 generates the verbal response and the non-verbal response corresponding to the intention of the speech of the user 11.

In step S805, the speech synthesis unit 711 synthesizes the speech sound of the conversation agent based on the verbal response generated by the generation unit 704.

In step S806, the drawing unit 712 draws the conversation agent based on the non-verbal response generated by the generation unit 704 in parallel with the processing of step S805.

In step S807, the output unit 713 outputs the speech sound of the conversation agent synthesized by the speech synthesis unit 711 and the conversation screen including the conversation agent drawn by the drawing unit 712. For example, the output unit 713 transmits the conversation screen to the terminal device 10, using the communication unit 701.

The conversation system 1 repeatedly executes the process of FIG. 8, and thus the conversation system 1 can change not only the speech sound of the conversation agent but also the non-verbal response of the conversation agent, based on the non-language information of the user 11. As a result, according to the present embodiment, in the conversation system 1 that performs a conversation with the user 11 using the conversation agent, the conversation system 1 can perform a more appropriate reaction with respect to the user 11.

### First Embodiment

The conversation system 1 according to the present embodiment can change the conversation scenario so that the conversation system 1 can be used for various uses. In the first embodiment, a description is given below of an example of the conversation processing corresponding to a business negotiation use.

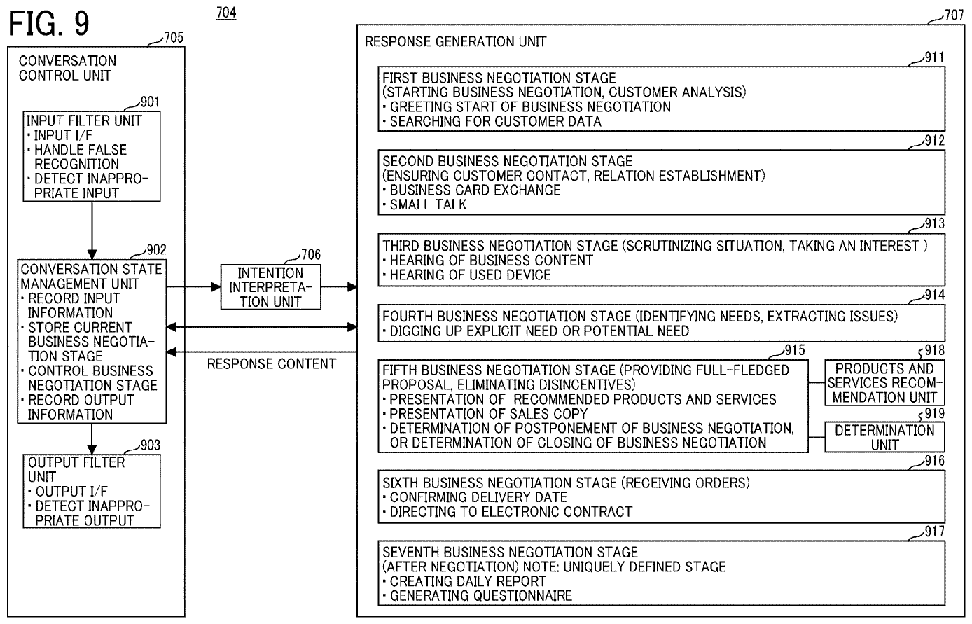

The conversation system 1 according to the first embodiment has, for example, a functional configuration as illustrated in FIG. 7. The generation unit 704 according to the first embodiment has, for example, a functional configuration as illustrated in FIG. 9.

FIG. 9 is a diagram illustrating the functional configuration of the generation unit 704 according to the first embodiment of the present disclosure. As illustrated in FIG. 9, the conversation control unit 705 of the generation unit 704 includes, for example, an input filter unit 901, a conversation state management unit 902, and an output filter unit 903.

The input filter unit 901 has, for example, a function of an input I/F that receives input of the language information and the non-language information of the user 11, a false recognition handling function, and a function to detect inappropriate input. The false recognition handling function and the function to detect inappropriate input are optional and may not be included.

The conversation state management unit 902 has, for example, a function to record input information, a function to store the current business negotiation stage, a function to control the business negotiation stage, and a function to record output information. The business negotiation stage is an example in which the progress of the business negotiation is defined by a numerical value.

The output filter unit 903 has, for example, a function of an output I/F that outputs the verbal response and the non-verbal response of the conversation agent, and a function to detect inappropriate output. The function to detect inappropriate output is optional and may not be included.

The intention interpretation unit 706 executes intention interpretation processing to interpret the intention of the speech of the user 11 based on the language information and the non-language information of the user 11 received by the conversation control unit 705. The intention interpretation unit 706 can estimate the intention of the user 11 from, for example, the language information and the context of the user 11. However, the intention interpretation unit 706 can add the non-language information of the user 11 to increase the probability of interpreting the intention of the user 11 more accurately.

For example, the speech of the user 11 “Are you serious?” is often used for a negative response, but is also used when the user 11 is happy to speak “Are you serious?” in a case where the expectation of the user 11 exceeds in a good sense as a positive response. In such a case, the intention interpretation unit 706 desirably more accurately interpret the intention of the user 11 using the non-language information of the user 11 as a clue.

For example, when the tone of the voice of the user 11 is high and the facial expression of the user 11 is cheerful as the non-language information of the user 11, the intention interpretation unit 706 may determine that the speech of the user 11 “Are you serious?” is positive (happy). In this case, the generation unit 704 may set the facial expression of the conversation agent to a smile and maintain the current conversation scenario.

On the other hand, when the tone of the voice of the user 11 is low and the facial expression of the image of the user 11 is dark, the intention interpretation unit 706 may determine that the speech of the user 11 “Are you serious?” is “negative”. In this case, the generation unit 704 may reduce the gesture of the conversation agent and transition to a conversation (products and services) scenario including a more detailed example (or may transition to a scenario of other products and services). In a business scene of business negotiation, delight, anger, sorrow, and pleasure of a business negotiation counterpart are unlikely to appear. Since non-language information that is judged to be negative is important information that can affect not only the progress of the business negotiation but also the formation of long-term sentiment that will influence the next business negotiation, it is desirable to carefully handle the non-language information. For example, it is desirable to determine whether the scenario can transition, considering the degree of low tone of the voice of the user 11 and even the degree of darkness of the facial expression of the user 11.

The response generation unit 707 includes multiple conversation scenarios 911 to 917 corresponding to multiple business negotiation stages 1 to 7, respectively, a products and services recommendation unit 918, and a determination unit 919. The products and services recommendation unit 918 and the determination unit 919 may be disposed outside the response generation unit 707.

The conversation scenario 911 corresponding to the first business negotiation stage is a conversation scenario used when a business negotiation starts. For example, greeting at the start of the business negotiation or searching for customer data is performed. The conversation scenario 912 corresponding to the second business negotiation stage is, for example, a conversation such as a business card exchange or a small talk. The conversation scenario 913 corresponding to the third business negotiation stage is, for example, a conversation such as hearing of business content or hearing of a used device. The conversation scenario 914 corresponding to the fourth business negotiation stage is a conversation such as confirmation of an explicit need of the customer or digging up of a potential need of the customer.

The conversation scenario 915 corresponding to the fifth business negotiation stage performs a conversation such as presentation of a recommended products and services, presentation of a sales copy for promoting purchase motivation, determination of postponement of the business negotiation, or determination of closing of the business negotiation. The conversation scenario 916 corresponding to the sixth business negotiation stage performs, for example, a conversation such as confirmation of delivery date or directing to electronic contract. The conversation scenario 917 corresponding to the seventh business negotiation stage performs a conversation such as creating daily report or questionnaire generation and sending.

The conversation state management unit 902 of the conversation control unit 705 selects a conversation scenario to be used from the multiple conversation scenarios 911 to 917 according to the current business negotiation state. For example, the conversation control unit 705 starts the business negotiation from the conversation scenario 911 corresponding to the first business negotiation stage, and raises the business negotiation stage as the business negotiation progresses. The conversation control unit 705 lowers the business negotiation stage when the user 11 is negative for the business negotiation.

Accordingly, the generation unit 704 can change the response content of the conversation agent according to the multiple negotiation stages set in advance. The business negotiation stages are examples of multiple conversation stages that are set in advance.

For example, in the fifth business negotiation stage, the products and services recommendation unit 918 executes product recommendation processing to select a product to be recommended to the user 11 based on the conversation content of the first business negotiation stage to the fourth business negotiation stage. For example, in the fifth business negotiation stage, the determination unit 919 executes determination processing to determine whether the business negotiation is to be postponed or to be closed based on the conversation content of the first business negotiation stage to the fifth business negotiation stage.

The number of business negotiation stages 1 to 7 illustrated in FIG. 9 is an example, and the number of business negotiation stages may be another number of two or more. The conversation content of the multiple conversation scenarios 911 to 917 illustrated in FIG. 9 are merely examples, and other content may be used.

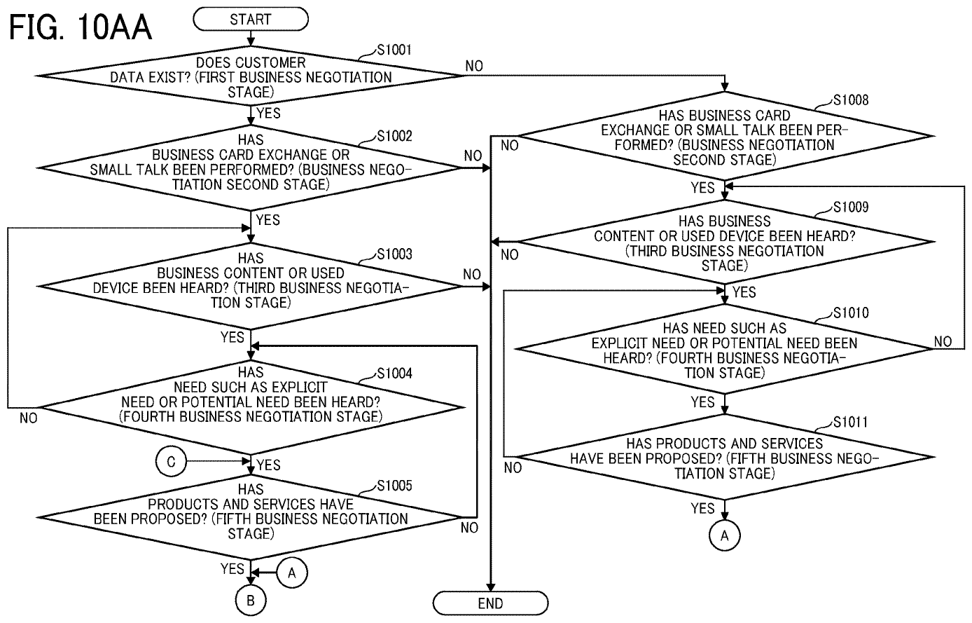

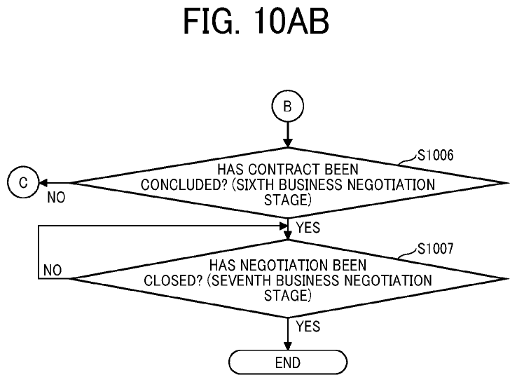

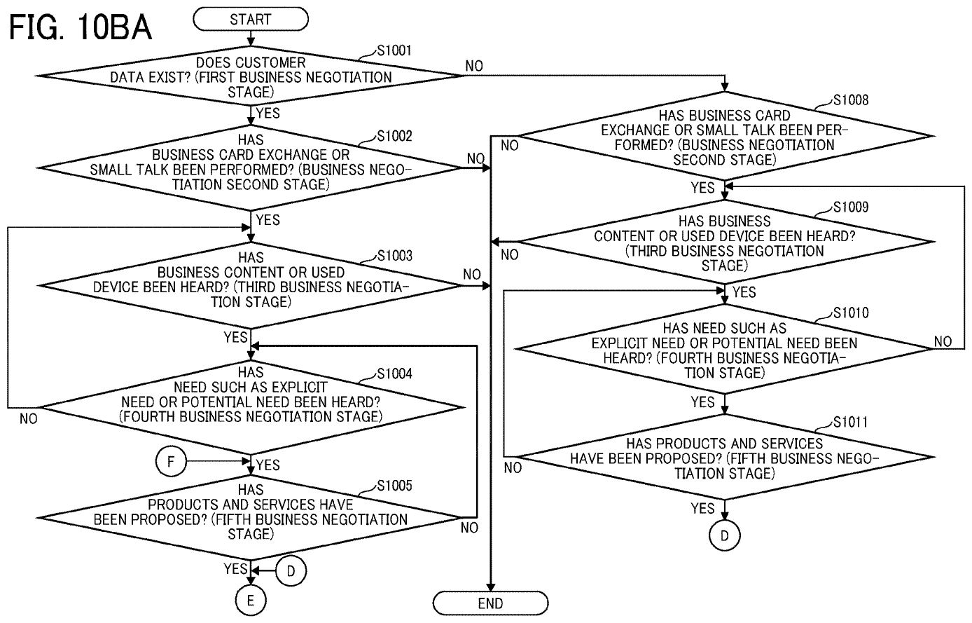

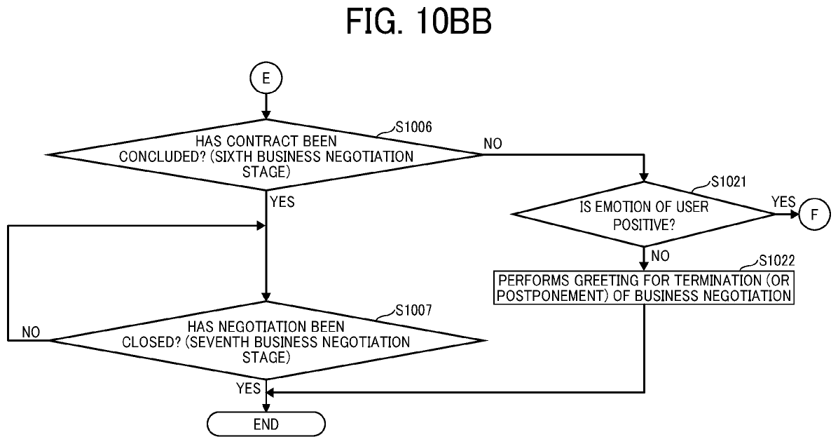

FIG. 10AA and 10AB are flowcharts of the conversation processing according to the first embodiment of the present disclosure. The conversation processing is an example of the conversation processing executed by the conversation system 1 having the functional configuration of the server apparatus 100 as illustrated in FIG. 7 and the functional configuration of the generation unit 704 as illustrated in FIG. 9.

In step S1001, the conversation system 1 starts a conversation of the conversation scenario 911 corresponding to the first business negotiation stage, and determines whether a customer data relating to the user 11 exists. When the conversation system 1 has the customer data, the conversation system 1 proceeds the processing to step S1002. On the other hand, when the conversation system 1 does not have the customer data, the conversation system 1 proceeds the processing to step S1008.

The processing of steps S1002 to S1005 and the processing of steps S1008 to S1011 are in the same negotiation stage, but the conversation scenarios to be used are different. For example, in the processing of steps S1002 to S1005, since the conversation system 1 has customer data, it is desirable to use a conversation scenario for proceeding with business negotiations based on past business negotiations. On the other hand, in the processing of steps S1008 to S1011, since the conversation system 1 does not have the customer data, it is desirable to use a conversation scenario in which the customer is carefully heard about information including information necessary for creating the customer data. Accordingly, the conversation agent can reduce the number of times that the conversation agent hears the same content each time from the user 11.

When the conversation system 1 proceeds to step S1002, the conversation system 1 performs a conversation of the conversation scenario 912 corresponding to the second business negotiation stage, and determines whether the business card exchange or the small talk has been performed. When the business card exchange or the small talk is performed, the conversation system 1 proceeds the processing to step S1004. On the other hand, when the business card exchange or the small talk has not been performed, the conversation system 1 ends, for example, the conversation processing (business negotiation) of FIG. 10AA. Preferably, the conversation system 1 closes the business negotiation when the business card exchange or the small talk has not been performed even after a predetermined time has elapsed from the start of the conversation in the conversation scenario 912 corresponding to the second business negotiation stage.

When the conversation system 1 proceeds to step S1003, the conversation system 1 performs a conversation of the conversation scenario 913 corresponding to the third business negotiation stage, and determines, for example, whether the conversation system 1 has heard the business content or the state of the used device. When the conversation system 1 has heard the business content or the state of the used device, the conversation system 1 proceeds the processing to step S1004. On the other hand, when the conversation system 1 has not heard the business content or the state of the used device, the conversation system 1 ends, for example, the conversation processing (business negotiation) of FIG. 10AA. Preferably, the conversation system 1 closes the business negotiation when the business content or the state of the used device has not heard even after a predetermined time has elapsed from the start of the conversation in the conversation scenario 913 corresponding to the third business negotiation stage.

When the conversation system 1 proceeds to step S1004, the conversation system 1 performs a conversation of the conversation scenario 914 corresponding to the fourth business negotiation stage, and determines, for example, whether a need such as a potential need or a predicted need has been heard. When the conversation system 1 has heard the need, the conversation system 1 proceeds the processing to step S1005. On the other hand, when the conversation system 1 has not heard the need, the conversation system 1 returns the processing back to step S1003.

When the conversation system 1 proceeds to step S1005, the conversation system 1 performs a conversation of the conversation scenario 915 corresponding to the fifth business negotiation stage, and determines whether the products and services have been proposed. When the products and services have been proposed, the conversation system 1 proceeds the processing to step S1006. On the other hand, when the products and services have not been proposed, the conversation system 1 returns the processing back to step S1004 or step S1005.

For example, the conversation system 1 uses the products and services recommendation unit 918 based on the information acquired in steps S1003 and S1004 to select the products and services to be proposed to the user 11. However, when the products and services recommendation unit 918 does not select the products and services to be proposed to the user 11 since the acquired information is insufficient, the conversation system 1 returns the processing back to step S1004 or step S1005.

When the conversation system 1 proceeds to step S1006, the conversation system 1 performs a conversation of the conversation scenario 916 corresponding to the sixth business negotiation stage, and determines whether a contract has been concluded. When the contract has been concluded, the conversation system 1 proceeds the processing to step S1007. On the other hand, when the contract has not been concluded, the conversation system 1, for example, returns the processing back to step S1005.

When the conversation system proceeds to step S1007, the conversation system 1 performs a conversation of the conversation scenario 917 corresponding to the seventh business negotiation stage, and determines whether the business negotiation has been organized. When the business negotiation has been organized, the conversation system 1 ends the conversation processing of FIG. 10AA and 10AB.

On the other hand, when the conversation system 1 proceeds from step S1001 to step S1008, the conversation system 1 performs a conversation of the conversation scenario 912 (for a new customer) corresponding to the second business negotiation stage, and determines whether the business card exchange or the small talk has been performed. When the business card exchange or the small talk is performed, the conversation system 1 proceeds the processing to step S1009. On the other hand, when the business card exchange or the small talk has not been performed, the conversation system 1 ends the conversation processing (business negotiation) of FIG. 10AA and 10AB. Preferably, the conversation system 1 closes the business negotiation when the business card exchange or the small talk has not been performed even after a predetermined time has elapsed from the start of the conversation in the conversation scenario 912 (for the new customer) corresponding to the second business negotiation stage.

When the conversation system 1 proceeds to step S1009, the conversation system 1 performs a conversation of the conversation scenario 913 (for the new customer) corresponding to the third business negotiation stage, and determines, for example, whether the conversation system 1 has heard the business content or the state of the used device. When the conversation system 1 has heard the business content or the state of the used device, the conversation system 1 proceeds the processing to step S1010. On the other hand, when the conversation system 1 has not heard the business content or the state of the used device, the conversation system 1 ends the conversation processing (business negotiation) of FIG. 10AA and 10AB. Preferably, the conversation system 1 closes the business negotiation when the situation has not heard even after a predetermined time has elapsed from the start of the conversation in the conversation scenario 913 (for the new customer) corresponding to the third business negotiation stage.

When the conversation system 1 proceeds to step S1010, the conversation system 1 performs a conversation of the conversation scenario 914 (for the new customer) corresponding to the fourth business negotiation stage, and determines, for example, whether a need such as a potential need or a predicted need has been heard. When the conversation system 1 has heard the need, the conversation system 1 proceeds the processing to step S1011. On the other hand, when the conversation system 1 has not heard the need, the conversation system 1 returns the processing back to step S1009.

When the conversation system 1 proceeds to step S1011, the conversation system 1 performs a conversation of the conversation scenario 915 (for the new customer) corresponding to the fifth business negotiation stage and determines whether the products and services have been proposed. When the products and services have been proposed, the conversation system 1 proceeds the processing to step S1006. On the other hand, when the products and services have not been proposed, the conversation system 1 returns the processing back to step S1010.

Through the process of FIG. 10AA and 10AB, the conversation system 1 can change the response content of the conversation agent according to the multiple conversation stages set in advance.

The conversation processing of FIG. 10AA and 10AB are examples. For example, when the contract has not been concluded in step S1006, the conversation system 1 may execute the processing of steps S1021 and S1022 of FIG. 10BB.

FIG. 10BA and 10BB are another flowcharts of the conversation processing according to the first embodiment of the present disclosure. In step S1006, when the contract has not been concluded, the conversation system 1 proceeds the processing to step S1021.

When the conversation system 1 proceeds to step S1021, the conversation system 1 determines whether an emotional analysis of the user 11 is positive. When the emotional analysis of the user 11 is positive, the conversation system 1 returns the processing back to step S1005. On the other hand, when the emotional analysis of the user 11 is not positive (when the emotional analysis of the user 11 is negative), the conversation system 1 proceeds the processing to step S1022.

When the conversation system 1 proceeds the processing to step S1022, the conversation system 1, for example, performs a greeting for termination (or postponement) of the business negotiation, and ends the conversation processing of FIG. 10BA and 10BB. For example, the conversation system 1 may cause the conversation agent to make a greeting for the end of the business negotiation and to make the conversation agent bow.

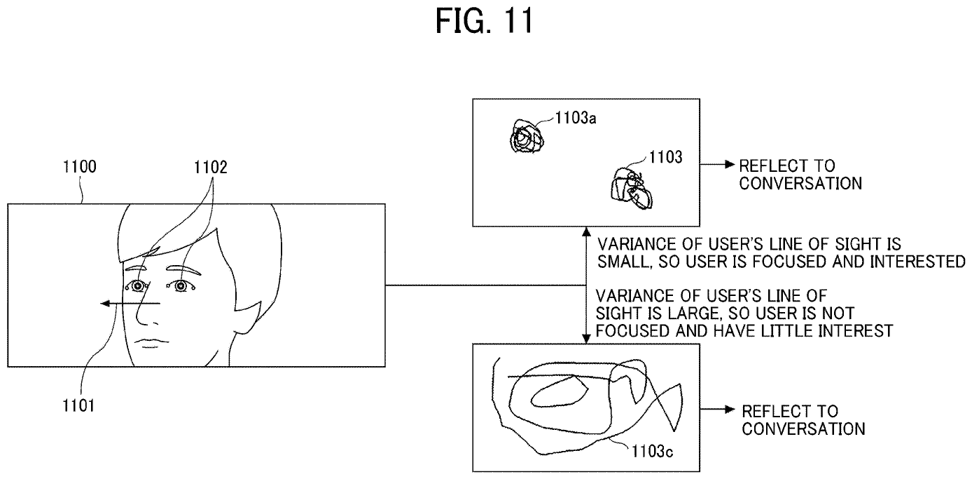

FIG. 11 is a diagram illustrating a use of non-language information according to the first embodiment of the present disclosure. For example, the conversation system 1 acquires a direction vector 1101 indicating the direction in which the face of the user 11 is facing from a video 1100 of the user 11, and acquires line-of-sight information indicating the line of sight of the user 11 based on the acquired direction vector 1101 and a position 112 of the pupils of the eyes of the user 11.

For example, when the user 11 is interested in the products and services presented by the conversation agent, the user 11 tends to gaze at the products and services displayed on the conversation screen, and thus the line of sight of the user 11 does not vary much (the variance is small), for example, as in lines of sight 1103a and 1103b. On the other hand, when the user 11 is not interested in the products and services presented by the conversation agent, the user 11 is less attentive, and thus the line of sight varies (the variance is large), for example, as line of sight 1103c.

Accordingly, the conversation system 1 may, for example, acquire the line-of-sight information indicating the line of sight of the user 11 after presenting the products and services to the user 11, and may determine that the emotional analysis of the user 11 is positive (the business negotiation is continued) when the variance of the line of sight is small. The conversation system 1 may, for example, acquire the line-of-sight information indicating the line of sight of the user 11 after presenting the products and services to the user 11, and may determine that the emotional analysis of the user 11 is negative (the business negotiation is ended or postponed) when the variance of the line of sight is large.

This method described above is not limited to the determination of the end (or postponement) of the business negotiation, and may be used, for example, to determine whether to transition to a higher negotiation stage or transition to a lower negotiation stage.

### Second Embodiment

In a second embodiment, a description is given blow of an example of the conversation processing corresponding to a nursing care use. In the nursing care use, a conversation scenario corresponding to a reminiscence method can be used. The reminiscence method is a psychological therapy in which an elderly person can stabilize his or her mind by speaking his or her past things and can expect enhancement of his or her cognitive function.

It is said that the conversation with a topic of a fond memory by the reminiscence method is a work in which the left brain verbalizes an image video floating in the right brain. The conversation that follows a storyline (such as introduction, development, turn, and conclusion) is called “when, where, who, what, and why (5W) conversation”, and the conversation that focus on the scene and how it happened is called “how (1H) conversation.” It is said that the enjoyment of the conversation that focuses on the scene or the scene at that time is doubled more than the story that follows a storyline.

In the second embodiment, the conversation system 1 provides a conversation scenario in which the multiple “how (1H) conversations” using the conversation scenario of the reminiscence method is held in order to make the conversation concretely deep corresponding to the progress of the conversation and generates the response content of the conversation agent based on the conversation scenario.

The functional configuration of the conversation system 1 according to the second embodiment may be the same as the functional configuration of the conversation system 1 described above with reference to FIG. 7.

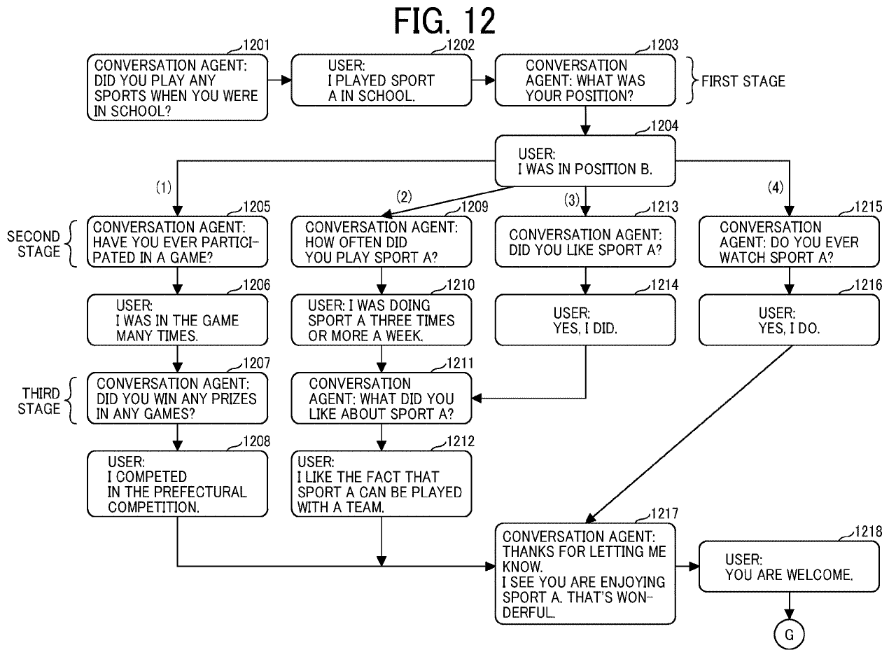

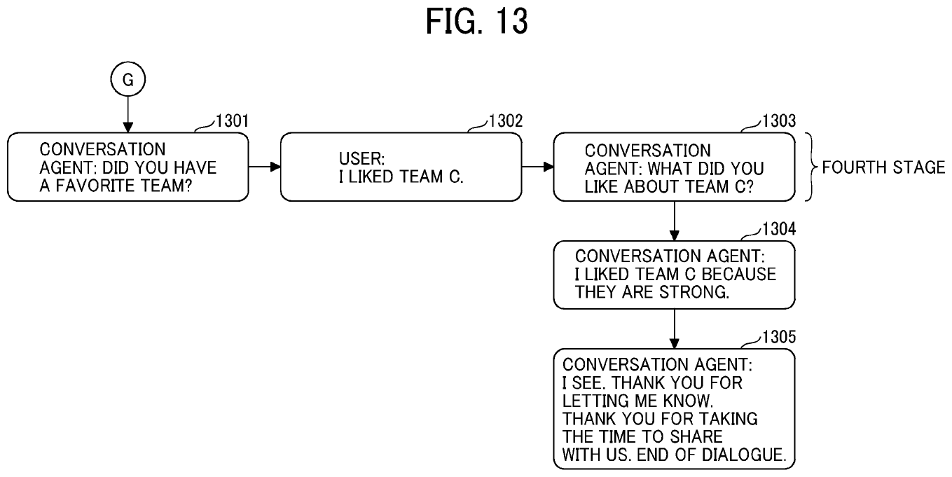

FIGS. 12 and 13 are diagrams illustrating the transition of the conversation scenario according to a second embodiment of the present disclosure. FIGS. 12 and 13 illustrate examples of transition of the conversation scenario of the reminiscence method. Since the actual transition changes depending on the speech of the user 11, FIGS. 12 and 13 illustrate examples of the transition when the user 11 speaks.

For example, it is assumed that the conversation agent speaks “Did you play any sports when you were in school?” in a state 1201, and the user 11 speaks “I played sport A in school.” in a state 1202 as an example.

In this case, the conversation system 1 causes the conversation agent to speak to review the general knowledge of the sport A as a first stage. For example, the conversation agent speaks “What was your position?” in a state 1203. In the state 1204, the user 11 is assumed to speak, for example, “I was in position B.”

In this case, the conversation system 1 causes the conversation agent to make a speech to dig into the topic of the sport A as a second stage. For example, the conversation agent randomly selects one state from states 1205, 1209, 1213, and 1215, and causes the state to transition to the selected state.

For example, when the state transitions to the state 1205, the conversation agent speaks “Have you ever participated in a game?” In the state 1206, the user 11 is assumed to speak “I was in the game many times.” as an example.

In this case, the conversation system 1 causes the conversation agent to make a speech to further dig into the topic of the state 1205 as a third stage. For example, the conversation agent speaks “Did you win any prizes in any games?” in a state 1207. In a state 1208, the user 11 is assumed to speak, for example “I competed in the prefectural competition.” In this case, the conversation system 1, for example, transitions the state to a state 1217.

As another example, when the state transitions from the state 1204 to the state 1209, the conversation agent speaks “How often did you play the sport A?” In a state 1210, the user 11 speaks “I was doing the sport A three times or more a week.” as an example.

In this case, the conversation system 1 causes the conversation agent to make a speech to further dig into the topic of the state 1209 as the third stage. For example, the conversation agent speaks “What did you like about the sport A?” in a state 1211. In the state 1212, the user 11 is assumed to speak, for example, “I like the fact that the sport A can be played with a team.” In this case, the conversation system 1, for example, transitions the state to a state 1217.

As another example, when the state transitions from the state 1204 to the state 1213, the conversation agent speaks “Did you like the sport A?” In a state 1214, the user 11 is assumed to speak, for example, “Yes, I did.” In this case, the conversation system 1, for example, transition the state to the state 1211.

As another example, when the state transitions from the state 1204 to the state 1215, the conversation agent speaks “Do you ever watch the sport A?” In a state 1216, the user 11 is assumed to speak, for example, “Yes, I do.” In this case, the conversation system 1, for example, transitions the state to a state 1217. As described above, the conversation system 1 may omit the digging in the third stage.

When the state transitions to the state 1217, the conversation agent is assumed to speaks “Thanks for letting me know. I see you are enjoying the sport A. That's wonderful.” In the state 1218, the user 11 is assumed to speak, for example, “You are welcome.” At this point, the conversation system 1, for example, may end the conversation, or may further transition the state to the state 1301 of FIG. 13.

When the state transitions to the state 1301, the conversation agent speaks, for example, “Did you have a favorite team?” In the state 1302, the user 11 is assumed to speak, for example, “I liked team C.”

In this case, the conversation system 1 causes the conversation agent to make a speech to dig into the topic about the favorite team (or selection) in the sport A as a fourth stage. For example, the conversation agent speaks “What did you like about team C?” in a state 1303. In a state 1304, the user 11 is assumed to speak, for example “I liked team C because they are strong.” In this case, the conversation system 1 causes the conversation agent to make a greeting for the end of conversation. For example, the conversation agent speaks “I see. Thank you for letting me know. Thank you for taking the time to share with us. End of conversation.” in a state 1305.

The conversation system 1 can cause the conversation agent to have the multiple “1H conversations” using the conversation scenario of the reminiscence method through the transitions of FIGS. 12 and 13 in order to make the conversation concretely deep corresponding to the progress of the conversation.

### Third Embodiment

For example, in the conversation screen 300 as illustrated in FIG. 3, not only the conversation by sound and the gesture of the virtual human 301, but also auxiliary visual information is added, whereby the conversation can be easily deepened in business negotiation and nursing care.

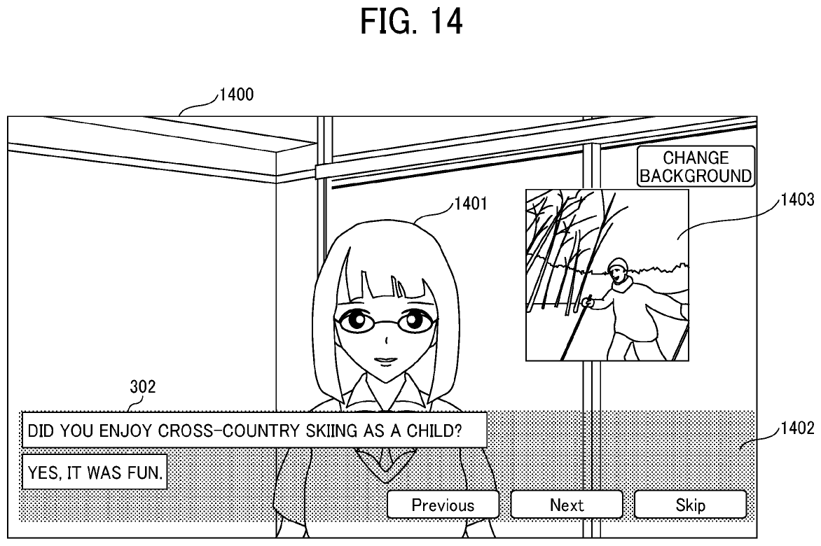

FIG. 14 is a diagram illustrating a conversation screen according to a third embodiment of the present disclosure. In FIG. 14, a conversation screen 1400 displays an illustration 1403, which is an image generated based on the conversation content, in addition to a virtual human (conversation agent) 1401 and a conversation 302 using a character string. The illustration 1403 allows the user 11 to easily visualize the image of the cross-country ski, which is the content of the conversation. The illustration 1403 may include sound information such as sound effects or sounds different from the conversation content.

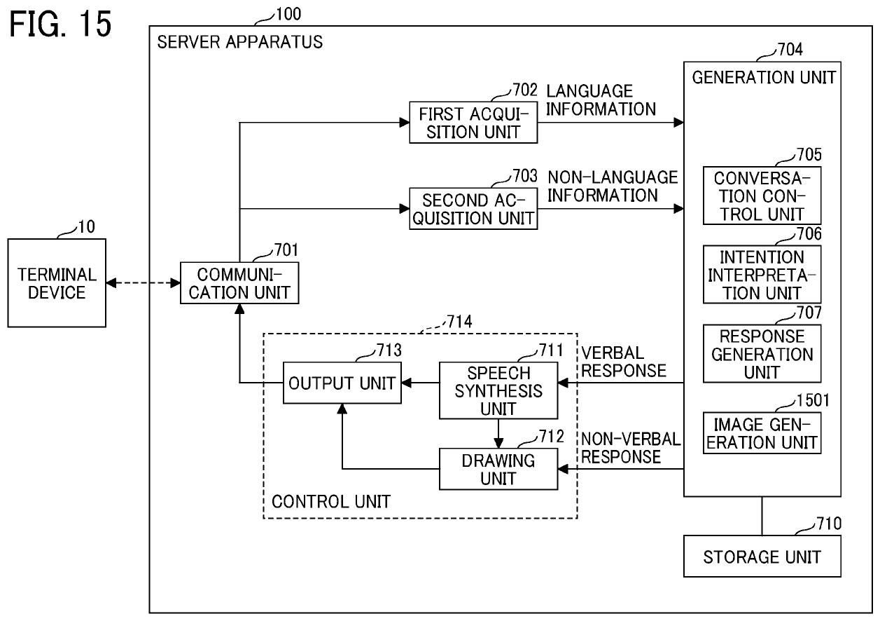

FIG. 15 is a diagram illustrating a functional configuration of the conversation system 1 according to the third embodiment of the present disclosure. As illustrated in FIG. 15, the server apparatus 100 according to the third embodiment includes an image generation unit 1501 in addition to the functional configuration of the server apparatus 100 described with reference to FIG. 7.

The image generation unit 1501 is, for example, included in the generation unit 704 and executes image generation processing to generate the illustration 1403 that is the image generated based on the content of the conversation with the user 11. For example, the image generation unit 1501 can use a pre-trained machine learning model (e.g., DALL-E, DALL-E 2, or stable diffusion) for generating an image from text information to generate the illustration 1403. The image generation unit 1501 may generate the illustration 1403 that is an image related to the conversation content based on at least one of the language information and the non-language information of the user 11.

For example, when the conversation system 1 determines that the emotional analysis of the user 11 is “positive” from the language information “cross-country ski” spoken by the user 11 and the non-language information “high tone” of the sound of the user 11, the image generation unit 1501 may generate the illustration 1403. Accordingly, the conversation system 1 can induce more reminiscence in the user 11 and perform effective conversation.

The functional configuration other than the image generation unit 1501 may be the same as the functional configuration of the conversation system 1 according to an embodiment of the present disclosure described with reference to FIG. 7.

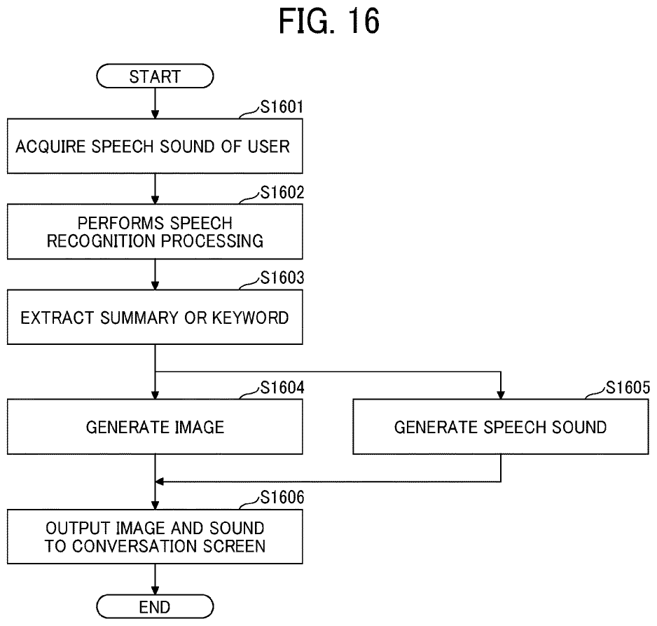

FIG. 16 is a flowchart of conversation processing according to the third embodiment of the present disclosure. The conversation processing is an example of the conversation processing executed by the conversation system 1 having the functional configuration illustrated in FIG. 15.

In step S1601, the first acquisition unit 702 acquires the speech sound of the user 11. In step S1602, the first acquisition unit 702 performs the speech recognition processing on the acquired speech sound of the user 11. Accordingly, the first acquisition unit 702 outputs language information of the user 11, which is text data into which the speech sound of the user 11 has been converted. The processing of steps S1601 and S1602 in FIG. 8 may perform, for example, in the same or substantially the same manner as the processing in step S801.

In step S1603, the image generation unit 1501 extracts a summary or a keyword from the speech sound of the user 11. In step S1604, the image generation unit 1501 generates, for example, an image such as the illustration 1403 described with reference to FIG. 14 based on the extracted summary or keyword.

In step S1605, the generation unit 704 generates, for example, a speech sound to be spoken by the conversation agent. The processing of steps S1604 and S1605 may perform, for example, in the same or substantially the same manner as the processing of steps S803 and S804 in FIG. 8. When the image generation unit 1501 generates the illustration 1403 of the cross-country ski as illustrated in FIG. 14, the generation unit 704 may generate a sound to be spoken by the conversation agent with respect to the cross-country ski.

In step S1606, the generation unit 704 outputs the image generated by the image generation unit 1501 and the sound generated by the generation unit 704 to the conversation screen 1400. At this time, the conversation system 1 may cause the virtual human 1401 to perform an operation of assisting the displayed illustration 1403 (e.g., the virtual human 1401 points with a finger).

Through the process of FIG. 16, the conversation system 1 can display, for example, the illustration 1403, which is an image related to the conversation content, on the conversation screen 1400 as illustrated in FIG. 14.

### Fourth Embodiment

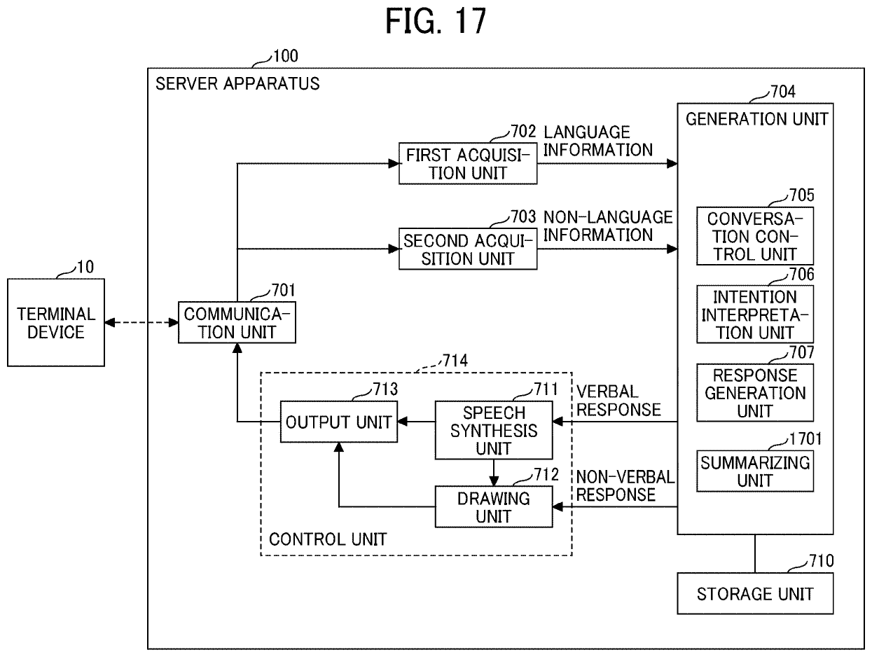

FIG. 17 is a diagram illustrating a functional configuration of the conversation system 1 according to a fourth embodiment of the present disclosure. As illustrated in FIG. 17, the server apparatus 100 according to the fourth embodiment includes a summarizing unit 1701 in addition to the functional configuration of the server apparatus 100 described with reference to FIG. 7.

The summarizing unit 1701 is, for example, included in the generation unit 704 and executes summarizing processing that summarizes a conversation log stored in the storage unit 710 by the conversation control unit 705 and creates, for example, a report.

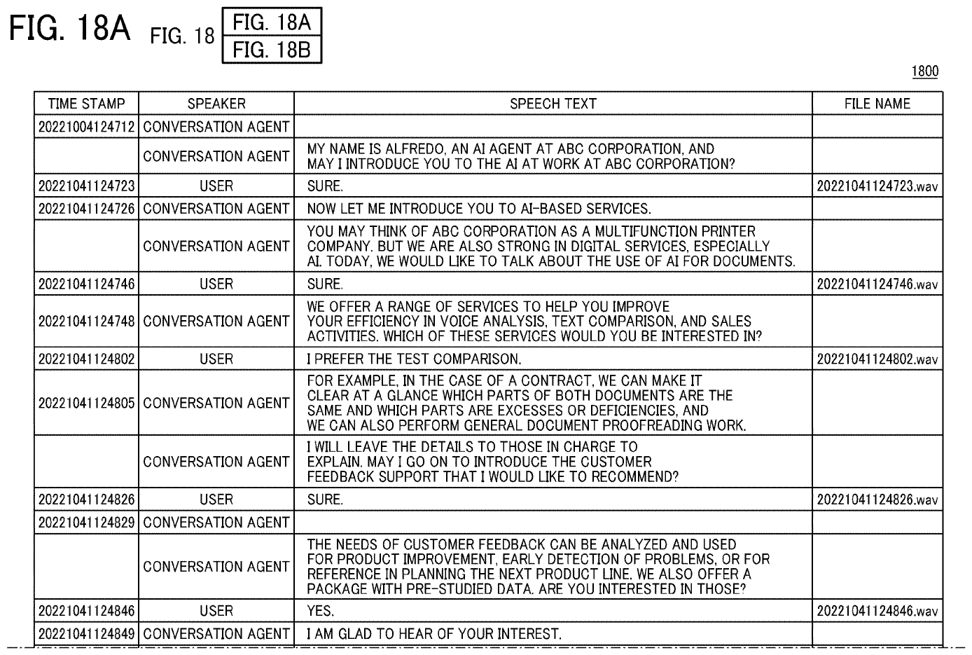

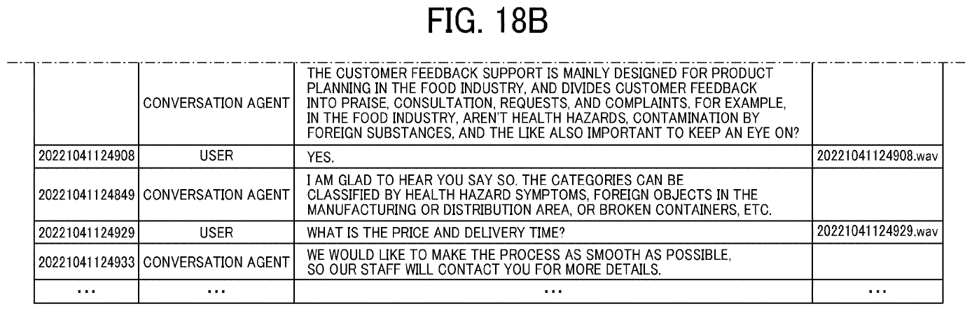

When the user 11 and the conversation agent start a conversation, the conversation control unit 705 of the conversation system 1 creates, for example, a conversation log 1800 as illustrated in FIGS. 18A and 18B and stores the conversation log 1800 in the storage unit 710.

In FIGS. 18A and 18B, the conversation log 1800 includes information items “TIME STAMP”, “SPEAKER”, “SPEECH TEXT”, and “FILE NAME”. The item “TIME STAMP” is information indicating the date and time when the user 11 or the conversation agent speaks. The item “SPEAKER” is information indicating whether the user 11 or the conversation agent speaks the speech content of the item “SPEECH TEXT”. The item “SPEECH TEXT” is information obtained by converting a speech sound of the user 11 or the conversation agent into text data. The “FILE NAME” is information indicating a file name of the speech sound of the user 11.

As illustrated in FIGS. 18A and 18B, since the conversation log 1800 is a record of all the conversations between the user 11 and the conversation agent, for example, it is desirable to summarize the record when the record is submitted as a report.

The summarizing unit 1701 may apply, for example, a large-scale language model to summarize the conversation log 1800. Alternatively, the summarizing unit 1701 may use a cloud service that is published as an AI for summarizing sentences to summarize the conversation log 1800.

Important information for summarization includes, for example, when, where, who, what, why, and how (5W1H) information such as date and time, place, and user information (e.g., an attribute and a new customer or an existing customer), problems or needs of user, information of proposed products and services, and information of action items or next schedule. The summarizing unit 1701 summarizes the conversation log 1800 to create a report or a meeting minute of conversation including the information described above.

The summarizing unit 1701 may determine that the user 11 is interested in the products and services presented by the speech agent based on language information such as “Yes” spoken by the user 11 and non-language information such as “high tone” of the sound of the user 11 and “facial expression is cheerful” of the user 11. In this case, when the summarizing unit 1701 creates summary sentences, it is desirable that the summarizing unit 1701 creates the summary sentences so that the descriptions of the products and services do not include any omissions.

### Fifth Embodiment

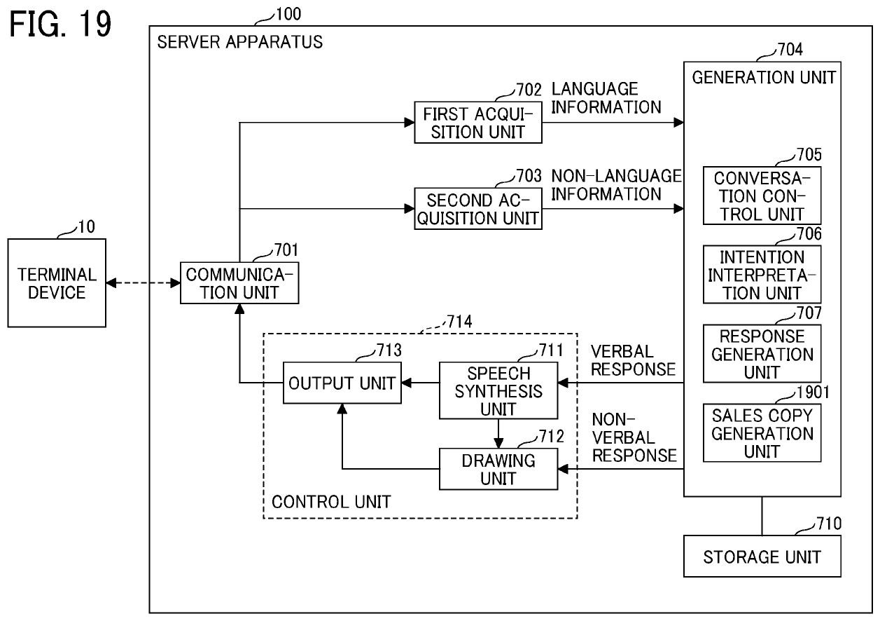

FIG. 19 is a diagram illustrating a functional configuration of the conversation system 1 according to a fifth embodiment of the present disclosure. As illustrated in FIG. 19, the server apparatus 100 according to the fifth embodiment includes a sales copy generation unit 1901 in addition to the functional configuration of the server apparatus 100 described with reference to FIG. 7.

The sales copy generation unit 1901 executes, for example, sales copy generation processing to generate a sales copy to be presented to the user 11 together with the products and services recommendation in the conversation scenario 915 corresponding to the fifth business negotiation stage illustrated in FIG. 9. The sales copy is an advertisement sentence or a blurb sentence that attracts attention of people. The sales copy is a character string to appeal to the user 11 the products and services to be proposed to the user 11.

As an example, it is assumed that the outline of the products and services to be proposed to the user 11 by the conversation agent is the needs analysis service having the following content. “It helps support centers and call centers in retail and wholesale, food and beverage, manufacturing, information and communication, services, pharmaceuticals and cosmetics, tourism, and other industries to enhance the quality and shorten the time desired to respond to customer inquiries. It also contextualizes and analyzes the enormous number of inquiries received from customers to assist in the planning of sales promotion measures and hints for new product and service development.” However, these sentences make the user 11 difficult to understand characteristics of the products and services to the user 11. Accordingly, the sales copy generation unit 1901 may generate, for example, the following sales copy. “Support from customer response to measure planning! AI thoroughly analyzes a customer.” Alternatively, the sales copy generation unit 1901 may generate, for example, the following sales copy. “AI learns and analyzes accumulated customer feedback! Leading to the best solution in a timely manner.” As another example, it is assumed that the outline of the products and services to be proposed to the user 11 by the conversation agent is the sales support service having the following content.

“The accumulation of customer conversation history and sales know-how depend on the individual and were not shared within the team. At the time of handover, it was time-consuming and inefficient to search through scattered data of customers. Our products and services reduces time-consuming search tasks in information sharing at the sales frontline, which tends to be a personalized process. For example, when reference information such as proposals for similar projects prepared by veteran salespeople can be shared, it solves issues such as the creation of documents that vary by skill level, and contribute to the development of documents for successful business negotiations.” However, these sentences make user 11 difficult to understand characteristics of the products and services to the user 11.

Accordingly, the sales copy generation unit 1901 may generate, for example, the following sales copy. “Immediate installation of customer's interest! AI supports successful business negotiation.” Alternatively, the sales copy generation unit 1901 may generate, for example, the following sales copy. “AI learns style of business that depends on personalized process! AI recommends a proposal document according to the interest of a customer.” Such sales copy can be efficiently generated by using, for example, a large-scale language model. The sales copy generation unit 1901 may use a sales copy generation service provided by an external cloud service to generate a sales copy.

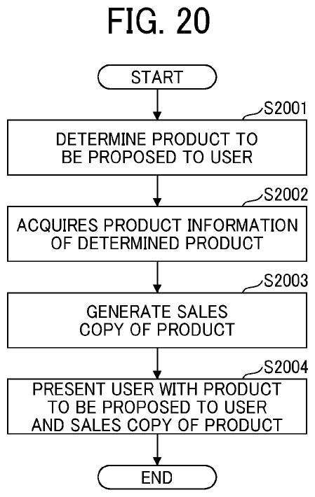

FIG. 20 is a flowchart of sales copy presentation processing of according to the fifth embodiment of the present disclosure. The sales copy presentation processing is an example of processing to generate a sales copy corresponding to a product to be proposed to the user 11, for example, in the conversation scenario 915 corresponding to the fifth business negotiation stage as illustrated in FIG. 9.

In step S2001, the products and services recommendation unit 918 of FIG. 9 determines products and services to be proposed to the user 11, for example, based on the content of the conversation performed in steps S1003 to S1004 of FIG. 10AA.

In step S2002, the sales copy generation unit 1901 in FIG. 19 acquires information of the products and services that is determined, from the storage unit 710.

In step S2003, the sales copy generation unit 1901 generates a sales copy of the products and services determined by the products and services recommendation unit 918, using acquired information of the products and services. As an example, the sales copy generation unit 1901 may use a sales copy generation service provided by an external cloud service to generate a sales copy. As another example, the sales copy generation unit 1901 may generate a sales copy using a large-scale language model.

In step S2004, the conversation system 1 presents the user 11 with the products and services to be proposed to the user 11 and the sales copy of the products and services. For example, the conversation system 1 displays information of the proposed products and services, and a sales copy of the products and services on the display 202 displayed on the conversation screen 200 as illustrated in FIG. 2.

The processing described above with reference to FIG. 20 is merely an example. For example, the products and services to be proposed to the user 11 may be a package of products and services obtained by combining a plurality of products and services. In this case, the sales copy generation unit 1901 acquires information of the multiple products and services in step S2002, and generates the sales copy using the information of the multiple products and services in step S2003.

The conversation system 1 according to the fifth embodiment can convey the value of the products and services to the user 11 in a straightforward and easy-to-understand manner.

### Sixth Embodiment

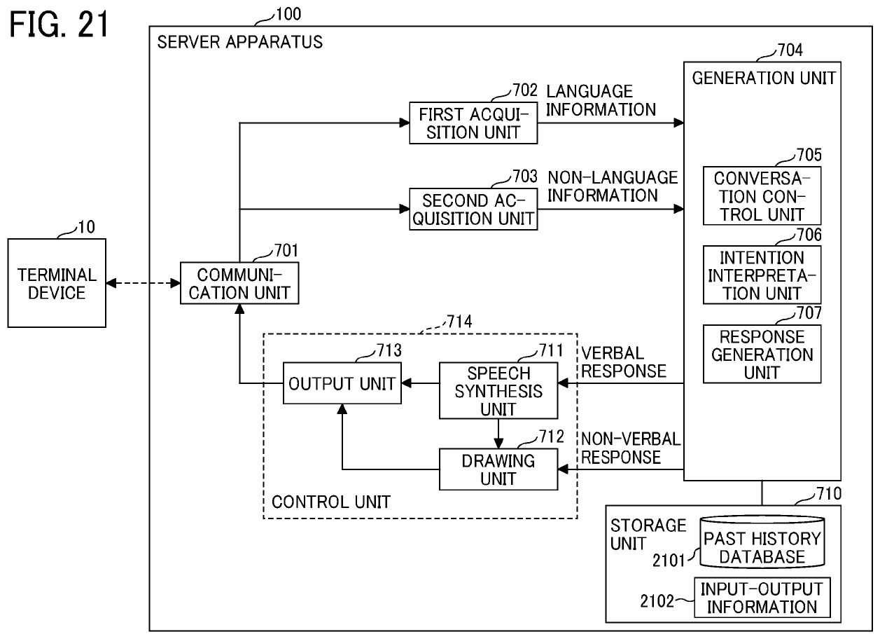

FIG. 21 is a diagram illustrating a functional configuration of the conversation system 1 according to a sixth embodiment of the present disclosure. As illustrated in FIG. 21, the server apparatus 100 according to the sixth embodiment includes a past history database (DB) 2101 and input-output information 2102 in the storage unit 710 in addition to the functional configuration of the server apparatus 100 described in FIG. 7. The input-output information 2102 is non-language information and the non-language information of the input-output information is referred to simply as input-output information in the following description.

The past history DB 2101 is, for example, a database that stores information such as a past conversation log, non-language information, and physical condition of the user 11.

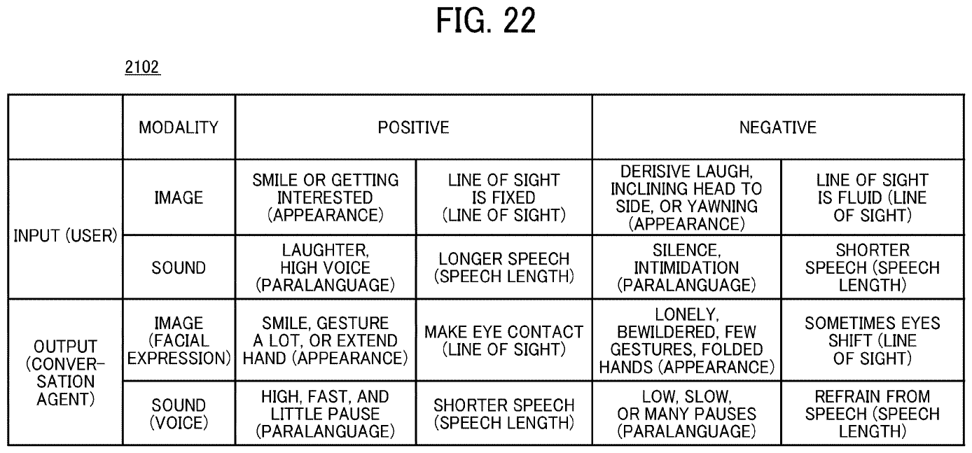

The input-output information 2102 includes, for example, information for determining whether non-language information acquired (input) from an image and sound of the user 11 is positive or negative, as illustrated in FIG. 22. The input-output information 2102 includes, for example, information indicating whether non-language information represented by an image and sound of the conversation agent is positive or negative, as illustrated in FIG. 22.

Accordingly, the intention interpretation unit 706 can easily determine whether the non-language information included in the image and the sound of the user 11 is positive or negative using the input-output information 2102. The response generation unit 707 can acquire an example of positive non-language information or negative non-language information of the conversation agent using the input-output information 2102.

When the second acquisition unit 703 acquires the non-language information of the user 11 from a conversation with the user 11 who uses the terminal device 10, the second acquisition unit 703 according to the sixth embodiment acquires non-language information (emotion) and non-language information (personality). The non-language information (emotion) includes non-language information that changes depending on a situation, such as emotion, attitude, words (strength, speed, or intonation), physiological characteristics, or body motion (line of sight or facial expression) of the user 11. For example, the intention interpretation unit 706 can determine whether the user 11 is positive or negative based on the non-language information (emotion) acquired by the second acquisition unit 703.

On the other hand, the non-language information (personality) includes non-language information (attribute information) that does not change or changes little depending on a situation, such as the gender, age, physical characteristics, or physical appearance of the user 11. For example, the response generation unit 707 can generate a verbal response or a non-verbal response according to the attribute (e.g., gender, age, or body type) of the user 11 based on the non-language information (personality) acquired by the second acquisition unit 703. The non-language information (personality) is an example of non-language information indicating the attribute of the user 11.

Other functional configurations of the conversation system 1 according to the sixth embodiment may be the same as the functional configurations of the conversation system 1 described in FIG. 7.

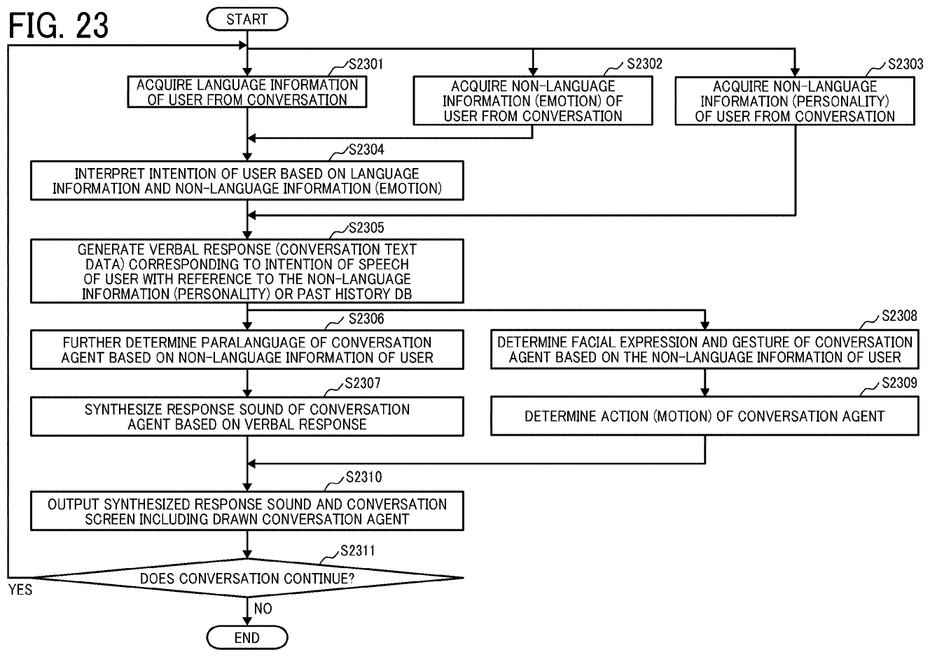

FIG. 23 is a flowchart of conversation processing according to the sixth embodiment of the present disclosure. The conversation processing is an example of processing executed by the conversation system 1 as illustrated in FIG. 21 after the conversation between the user 11 and the conversation agent is started. A detailed description of the same or substantially the same processing as the outline of conversation processing according to an embodiment described with reference to FIG. 8 is omitted in the following description.

In step S2301, the first acquisition unit 702 acquires the language information of the user 11 from the conversation between the user 11 and the conversation agent.

In steps S2302 and S2303, the second acquisition unit 703 acquires non-language information (emotion) and non-language information (personality) of the user 11 from the conversation between the user 11 and the conversation agent in parallel with the processing of step S2301.

In step S2304, the generation unit 704 interprets the intention of the speech of the user 11 based on the language information acquired by the first acquisition unit 702 and the non-language information (emotion) acquired by the second acquisition unit 703.

In step S2305, the generation unit 704 generates a verbal response (conversation sentence) corresponding to the intention of the speech of the user 11 with reference to the non-language information (personality) acquired by the second acquisition unit 703 or the past history DB 2101. For example, the generation unit 704 determines the gender, hobby, or body type of the user 11 from the past conversation history with the user 11 in the past history DB 2101, and generates a different verbal response (conversation sentence) according to the gender, hobby, or body type of the user 11.

When there is no past conversation history with the user 11, the generation unit 704 may detect a region of face from the image of the user 11, and estimate the gender or age of the user 11 using, for example, an age and gender estimation AI. The generation unit 704 may estimate the body type of the user 11 from the image of the user 11 using a body type estimation AI. The generation unit 704 may determine the hobby of the user 11 from the language information of the user 11. The generation unit 704 stores the estimated gender, age, or body type of the user 11 in the past history DB 2101.

As a specific example, it is assumed that the generation unit 704 determines that the user 11 is a woman in her 40s and has a hobby of cosmetics from the language information and the non-language information of the user 11 during the business negotiation. In this case, the generation unit 704 may determine that it is worth introducing or proposing a cosmetic products and services for the 40s, and may generate, for example, a verbal response for introducing specific products and services.

As another example, the generation unit 704 may estimate the body type of the user 11 from the image of the user 11 during business negotiation, compare the body type of the user 11 with the history of the body type of the user 11 in the past, and monitors the transition of the body type of the user 11, or compare body type of the user 11 with the body type of the user 11 in the past. Accordingly, the generation unit 704, for example, may generate a verbal response to introduce products and services such as a low-sugar ingredient or a weight management application program to the user 11 who has recently become fat.

As another example, the generation unit 704 may estimate the degree of clothes fashionability of the user 11 from the image of the user 11 during business negotiation and compare the degree of clothes fashionability of the user 11 in the past. Accordingly, the generation unit 704 may generate a verbal response to introduce specific products and services to the user 11 who determines that it is worth preferentially introducing clothing-related products and services.

As another example, the generation unit 704 may estimate the body type of the user 11 from the image of the user 11 during business negotiation, and determine whether the physical condition of the user 11 needs to be checked in combination with the medical history information of the past history. Accordingly, the generation unit 704 may generate a verbal response to confirm the current physical condition for the user 11 who has been determined that the physical condition needs to be confirmed.

In step S2306, the generation unit 704 determines the paralanguage of the conversation agent (e.g., a tone of voice, a speaking speed, a pitch of voice, strength of voice, coughing, sighing, laughing, or silence) based on the generated verbal response and the non-language information of the user 11. For example, when the generation unit 704 determines that the emotional analysis of the user 11 is positive with reference to the input-output information 2102 illustrated in FIG. 22, the generation unit 122 may acquire positive non-language information (paralanguage) of the conversation agent from the input-output information 2102. Similarly, when the generation unit 704 determines that the emotional analysis of the user 11 is negative with reference to the input-output information 2102 as illustrated in FIG. 22, the generation unit 122 may acquire negative non-language information (paralanguage) of the conversation agent from the input-output information 2102.

The input-output information 2102 illustrated in FIG. 22 is an example. Various positive non-language information and negative non-language information of the user 11 and various positive non-language information and negative non-language information of the conversation agent are registered in advance in the input-output information 2102.

In step S2307, the control unit 714 synthesizes a response sound of the conversation agent based on the verbal response generated by the generation unit 704 and the paralanguage determined by the generation unit 704.

The server apparatus 100 executes the processing of steps S2306 and S2307 in parallel with the processing of steps S2308 and S2309.

In step S2308, the generation unit 704 determines a facial expression, a line of sight, and a gesture of the conversation agent based on the non-language information of the user 11. For example, when the generation unit 704 determines that the emotional analysis of the user 11 is positive with reference to the input-output information 2102 illustrated in FIG. 22, the generation unit 131 acquires positive non-language information (a facial expression, a line of sight, and a gesture) of the conversation agent from the input-output information 2102. Similarly, when the generation unit 704 determines that the emotional analysis of the user 11 is negative with reference to the input-output information 2102 illustrated in FIG. 22, the generation unit 131 acquires negative non-language information (the facial expression, the line of sight, and the gesture) of the conversation agent from the input-output information 2102.

In step S2309, the generation unit 704 determines action (motion) of the conversation agent based on the determined facial expression, line of sight, and gesture of the conversation agent.

As a specific example, when the generation unit 704 determines that the emotional analysis of the user 11 is positive during the business negotiation, the generation unit 704 may, for example, make the conversation agent smile and make the hand gesture large. When the generation unit 704 determines that the emotional analysis of the user 11 is negative during the business negotiation, the generation unit 704 may, for example, make the conversation agent look lonely and cause the conversation agent to nod or bow. The generation unit 704 may cause the conversation agent operate (motion) based on non-language information (personality) in addition to the positive or negative determination. For example, in the case of positive determination, the conversation agent is caused to execute an operation corresponding to (similar to) the non-language information (personality) of the user 11 such as a hand gesture, a shape of the crossed arm, or pace and rhythm of conversation of the user 11 recorded in the past history DB 2101.

In step S2310, the control unit 714 draws the conversation agent based on the operation of the conversation agent determined by the generation unit 704, and outputs a conversation screen including the drawn conversation agent and the synthesized response sound. For example, the output unit 713 transmits the conversation screen to the terminal device 10, using the communication unit 701.

For example, the conversation system 1 repeatedly executes the process of FIG. 8, and thus the conversation system 1 can perform a more appropriate reaction with respect to the user 11, based on the non-language information (personality) of the user 11 or the past history DB 2101.

A description is given below of an example of a usage scene of the conversation system 1 according to the present embodiment.

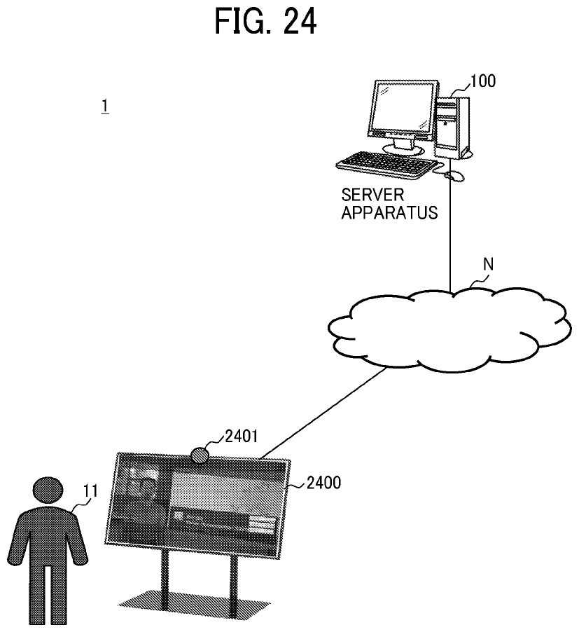

FIG. 24 is a diagram illustrating a system configuration of a usage scene 1 according to an embodiment of the present disclosure. The usage scene 1 indicates an example of a case where the terminal device 10 of FIG. 1 is a signage terminal 2400, which is a digital signage. In FIG. 24, the signage terminal 2400 includes an input device 2401 such as a camera and a microphone, and a hardware configuration of a computer.

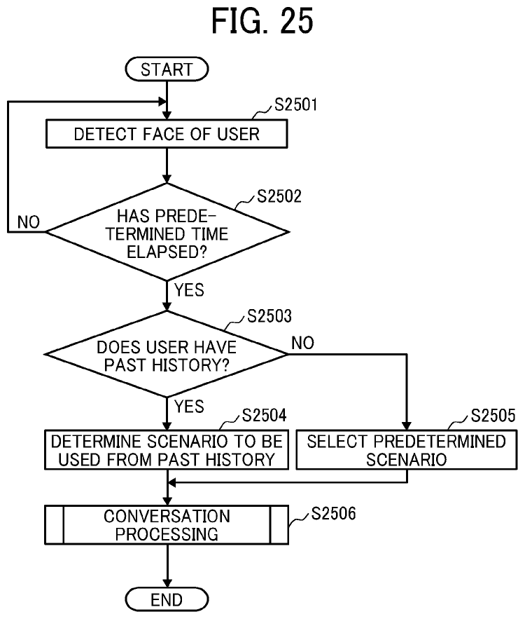

FIG. 25 is a flowchart of conversation start processing of the usage scene 1 according to an embodiment of the present disclosure.

In step S2501, the conversation system 1 detects a face of the user 11 from an image captured by the input device 2401 included in the signage terminal 2400. As a specific example, the conversation system 1 extracts a face image of the user 11 from the image captured by the input device 2401, and performs face authentication on the extracted face image. When the extracted face image is authenticated by the face authentication, the conversation system 1 determines that the face of the user 11 is detected.

In step S2502, the conversation system 1 determines whether the face detection of the user 11 has continued for a predetermined time. For example, the conversation system 1 determines whether the state in which the face of the user 11 is detected continues for a predetermined time (e.g., five seconds). When the face detection continues for the predetermined time, the conversation system 1 proceeds the processing to step S2503. On the other hand, when the face detection does not continue for the predetermined time, the conversation system 1 returns the processing back to step S2501. The processing of steps S2501 and S2502 may be performed by signage terminal 2400 or server apparatus 100.

In step S2503, the server apparatus 100 determines whether the user 11 has a past history.

For example, when the server apparatus 100 refers to the past history DB 2101 and there is a past conversation log of the user 11, the server apparatus 100 determines that there is a past history of the user 11. When there is the past history of the user 11, the server apparatus 100 proceeds the processing to step S2504. On the other hand, when there is no past history of the user 11, the server apparatus 100 proceeds the processing to step S2505.

In step S2504, the server apparatus 100 determines a scenario to be used for the conversation processing from the past history (past conversation log) of the user 11. Accordingly, the conversation system 1 can prevent the same user 11 from repeatedly asking the same question or making the same speech.

In step S2505, the server apparatus 100 selects a predetermined scenario (e.g., a scenario for a new customer) as a scenario used for the conversation processing.

In step S2506, the conversation system 1 executes, for example, the conversation processing described in FIGS. 1 to 23 with the signage terminals 2400. Through the process of FIG. 25, the conversation system 1 can use the signage terminal 2400 to provide the user 11 with the conversation service. The conversation system 1 can change the conversation content provided to the user 11 based on the past conversation history of the user 11. The processing of steps S2703 to S2705 is optional and is not requested. For example, the conversation system 1 may determine the scenario used for the conversation in the conversation processing of step S2506.

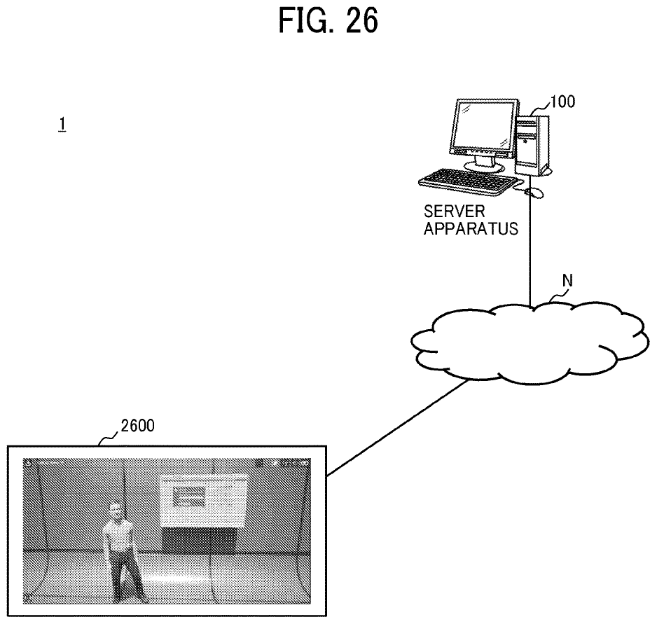

FIG. 26 is a diagram illustrating a system configuration of a usage scene 2 according to an embodiment of the present disclosure. The usage scene 2 indicates an example of a case where the terminal device 10 of FIG. 1 is a display terminal 2600 for a metaverse. The display terminal 2600 includes, for example, a head mounted display or a metaverse display for a spatial reproduction display, and a configuration of a computer. The conversation system 1 uses the conversation agent on a virtual space to provide the conversation service to the user 11.

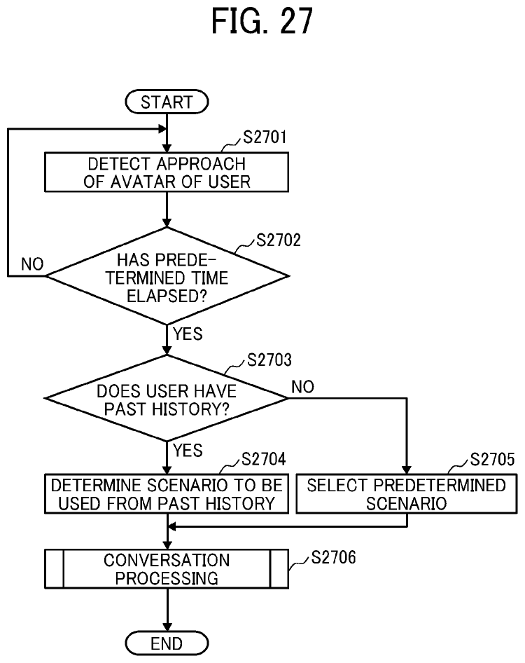

FIG. 27 is a flowchart of conversation start processing of the usage scene 2 according to an embodiment of the present disclosure.

In step S2701, the conversation system 1 detects an approach of an avatar of the user 11 on the virtual space. For example, the conversation system 1 detects whether the avatar of the user 11 have approached within a predetermined range (e.g., within one meter) from the login information of the user 11, the coordinates of the avatar of the user 11 on the virtual space, and the coordinates of the conversation agent. In step S2702, the conversation system 1 determines whether the state in which the avatar of the user 11 have approached within the predetermined range (e.g., within one meter) has continued for a predetermined time (e.g., five seconds). When the approach of the avatar of the user 11 has continued for the predetermined time, the conversation system 1 proceeds the processing to step S2703. On the other hand, when the approach of the avatar of the user 11 has not continued for the predetermined time, the conversation system 1 returns the processing back to step S2701.

In step S2703, the server apparatus 100 determines whether the user 11 has a past history. For example, when the server apparatus 100 refers to the past history DB 2101 and there is a past conversation log of the user 11, the server apparatus 100 determines that there is a past history of the user 11. When there is the past history of the user 11, the server apparatus 100 proceeds the processing to step S2704. On the other hand, when there is no past history of the user 11, the server apparatus 100 proceeds the processing to step S2705.

In step S2704, the server apparatus 100 determines a scenario to be used for the conversation processing from the past history (past conversation log) of the user 11. In step S2705, the server apparatus 100 selects a predetermined scenario (e.g., a scenario for a new user) as a scenario used for the conversation processing.

In step S2706, the conversation system 1 executes, for example, the conversation processing described with reference to FIGS. 1 to 23 on the virtual space. Through the process of FIG. 27, the conversation system 1 can uses the display terminal 2600 for metaverse to provide the user 11 with the conversation service on the virtual space.

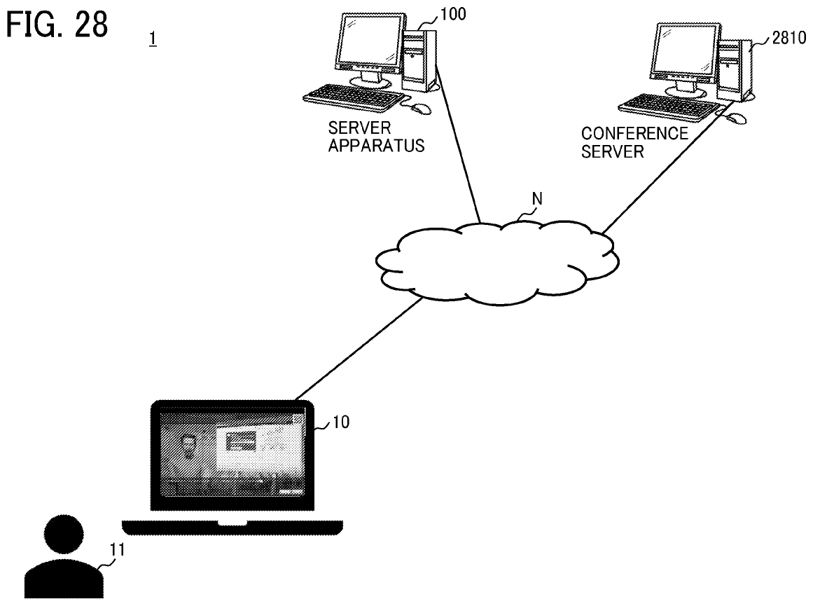

FIG. 28 is a diagram illustrating a system configuration of a usage scene 3 according to an embodiment of the present disclosure. The usage scene 3 indicates an example of a case where the user 11 uses the terminal device 10 to hold a web conference with the conversation agent provided by the server apparatus 100. The user 11 may participate in a web conference provided by a conference server 2810 outside the system, or the server apparatus 100 may provide a web conference.

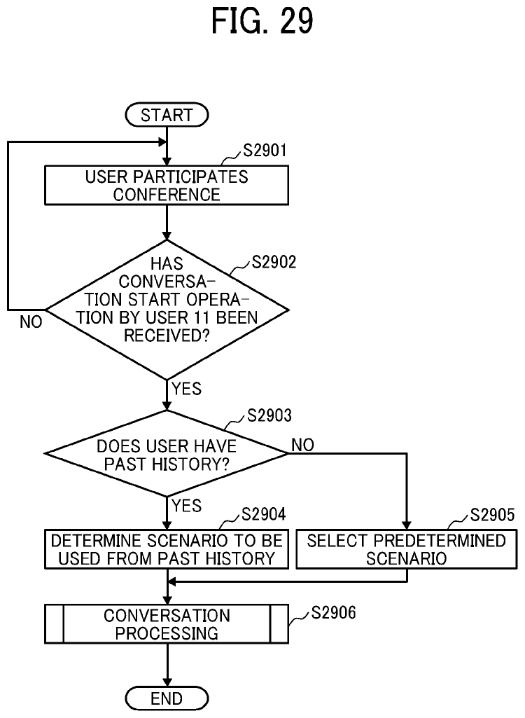

FIG. 29 is a flowchart of the conversation start processing of the usage scene 2 according to an embodiment of the present disclosure.

In step S2901, it is assumed that the user 11 participates in the web conference in which the conversation agent provided by the conversation system participates, using the terminal device 10. For example, the user 11 accesses a link to participate in the web conference with the conversation agent, using the terminal device 10 to participate in the web conference.

In step S2902, the conversation system 1 determines whether a conversation start operation by the user 11 has been received in the web conference. When the conversation start operation by the user 11 has been received, the conversation system 1 proceeds the processing to step S2903. On the other hand, when the conversation start operation by the user 11 has not been received, the conversation system 1, for example, repeatedly executes the processing of step S2902.

In step S2903, the server apparatus 100 determines whether the user 11 has a past history. For example, when the server apparatus 100 refers to the past history DB 2101 and there is a past conversation log of the user 11, the server apparatus 100 determines that there is a past history of the user 11. When there is the past history of the user 11, the server apparatus 100 proceeds the processing to step S2904. On the other hand, when there is no past history of the user 11, the server apparatus 100 proceeds the processing to step S2905.

In step S2904, the server apparatus 100 determines a scenario to be used for the conversation processing from the past history (past conversation log) of the user 11. In step S2905, the server apparatus 100 selects a predetermined scenario (e.g., a scenario for a new user) as a scenario used for the conversation processing.

In step S2906, the conversation system 1 executes, for example, the conversation processing described with reference to FIGS. 1 to 23 in the web conference. Through the process of FIG. 29, the conversation system 1 can use the web conference to provide the user 11 with the conversation service.

As described above, the conversation system 1 according to the present embodiment performs a conversation with the user 11 using the conversation agent. As a result, the conversation system 1 can perform a more appropriate reaction with respect to the user 11.

Each of the functions of the described embodiments can be implemented by one or more processing circuits or circuitry. In the embodiments of the present disclosure, the processing circuit includes a processor programmed to execute each of the functions by software such as a processor implemented by an electronic circuit, and a device such as an application-specific integrated circuit (ASIC), a digital signal processor (DSP), a field-programmable gate array (FPGA), or a circuit module designed to execute each function described above.

The group of apparatuses or devices described in the above-described embodiments are merely one example of multiple types of computing environments that implement the embodiments of the present disclosure. In some embodiments, the server apparatus 100 includes multiple computing devices, such as server clusters. The multiple computing devices are configured to communicate with one another through any type of communication link, including a network, a shared memory, etc., and perform the processes disclosed herein.

Each functional unit of the server apparatus 100 may be integrated into one server or may be divided into multiple servers. The terminal device 10 may include at least part of the functional units of the server apparatus 100.

A description is given below of some aspects of the present disclosure. In this specification, a conversation system, a conversation control method, and a program according to several examples are disclosed.

### Aspect 1

A conversation system is a system that performs a conversation with a user, using a conversation agent. The conversation system includes a first acquisition unit, a second acquisition unit, a generation unit, and a control unit. The first acquisition unit acquires language information of the user from the conversation. The second acquisition unit acquires non-language information of the user from the conversation. The generation unit generates response content including a verbal response and a non-verbal response of the conversation agent based on the language information of the user and the non-language information of the user. The control unit controls the conversation agent based on the response content generated by the generation unit.

### Aspect 2

In the conversation system according to Aspect 1, the response content of the conversation agent includes the non-verbal response of the conversation agent. The generation unit changes the non-verbal response of the conversation agent in accordance with the non-language information of the user.

### Aspect 3

In the conversation system according to Aspect 2, the generation unit changes content of the action of the conversation agent in accordance with the non-language information of the user.

### Aspect 4

In the conversation system according to Aspect 2 or Aspect 3, the generation unit changes a timing of the action of the conversation agent in accordance with the non-language information of the user.

### Aspect 5

In the conversation system according to any one of Aspects 1 to 4, the non-language information of the user includes information of a facial expression, a line of sight, posture, or an emotion acquired from an image of the user.

### Aspect 6

In the conversation system according to any one of Aspects 1 to 5, the non-language information of the user includes information of volume of voice, intonation of the voice, or tone of the voice acquired from sound of the user.

### Aspect 7

In the conversation system according to any one of Aspects 1 to 6, the generation unit changes the response content of the conversation agent in accordance with a scenario of the conversation.

### Aspect 8

In the conversation system according to any one of Aspects 1 to 7, the generation unit changes the response content of the conversation agent in accordance with a plurality of conversation stages set in advance.

### Aspect 9

In the conversation system according to Aspect 8, the generation unit changes the conversation stage based on line-of-sight information of the user.

### Aspect 10

The conversation system according to any one of Aspects 1 to 10 further includes an image generation unit that generates an image related to conversation content based on the language information of the user. The conversation system performs a conversation with the user using the conversation agent and the image.

### Aspect 11

The conversation system according to any one of Aspects 1 to 10 further includes a summarizing unit that summarizes the conversation based on a conversation log of the conversation.

### Aspect 12

In the conversation system according to any one of Aspects 1 to 11, the conversation is a business negotiation with the user. The conversation system proposes products and services based on the conversation content of the business negotiation.

### Aspect 13

The conversation system according to any one of Aspect 12 presents a sales copy of products and services based on the conversation content of the business negotiation.

### Aspect 14

The conversation system according to any one of Aspects 1 to 13 further includes a database that stores a past history of the conversation. The generation unit changes the scenario of the conversation based on the past history of the conversation.

### Aspect 15

In the conversation system according to any one of Aspects 1 to 14, the generation unit generates the verbal response of the conversation agent with reference to the past history of the conversation.

### Aspect 16

In the conversation system according to any one of Aspects 1 to 15, the second acquisition unit acquires the non-language information indicating an attribute of the user from the conversation. The generation unit generates the verbal response or the non-verbal response in accordance with the attribute of the user.

### Aspect 17

In a conversation system that performs a conversation with a user, using a conversation agent, a conversation control method is performed by a computer. The conversation control method includes: acquiring language information of the user from the conversation; acquiring non-language information of the user from the conversation; generating response content including a verbal response and a non-verbal response of the conversation agent based on the language information of the user and the non-language information of the user; and controlling the conversation agent based on the response content generated by the generation unit.

### Aspect 18

A program is performed by a computer. The program causes the conversation system that performs a conversation with a user, using a conversation agent, to execute a process. The process includes: acquiring language information of the user from the conversation; acquiring non-language information of the user from the conversation; generating response content including a verbal response and a non-verbal response of the conversation agent based on the language information of the user and the non-language information of the user; and controlling the conversation agent based on the response content generated by the generation unit.

The embodiments described above are illustrative and do not limit the present invention.

Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium may also include a storage medium for storing processor readable code such as a floppy disk, a hard disk, a compact disc read-only memory (CD-ROM), a magnetic tape device, or a solid state memory device.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

This patent application is based on and claims priority to Japanese Patent Application No. 2023-017067, filed on Feb. 7, 2023, and 2023-221852, filed on Dec. 27, 2023, in the Japan Patent Office, the entire disclosure of which is hereby incorporated by reference herein.

### REFERENCE SIGNS LIST

1: conversation system
10: terminal device
100: server apparatus
200, 300: conversation screen
201, 301, 1401: virtual human (conversation agent)
500: computer
702: first acquisition unit
703: second acquisition unit
704: generation unit
714: control unit
1501: image generation unit
1701: summarizing unit
1901: sales copy generation unit

1. A conversation system for performing a conversation with a user using a conversation agent, the conversation system comprising:
processing circuitry configured to
acquire language information of the user from the conversation;
acquire non-language information of the user from the conversation;
generate response content including a verbal response and a non-verbal response of the conversation agent, the verbal response being based on the language information of the user and the non-verbal response being based on the non-language information of the user; and
control the conversation agent based on the response content.

2. The conversation system according to claim 1,
the processing circuitry is configured to generate the non-verbal response of the conversation agent in accordance with the non-language information of the user.

3. The conversation system according to claim 2, wherein the processing circuitry is configured to change content of an action of the conversation agent in accordance with the non-language information of the user.

4. The conversation system according to claim 2, wherein the processing circuitry is configured to change a timing of an action of the conversation agent in accordance with the non-language information of the user.

5. The conversation system according to claim 1, wherein the non-language information of the user includes information on a facial expression, line of sight, posture, or emotion each acquired from an image of the user.

6. The conversation system according to claim 5, wherein the non-language information of the user includes information on volume of voice, intonation of the voice, or tone of the voice each acquired from sound of the user.

7. The conversation system according to claim 1, wherein the processing circuitry is configured to change the response content of the conversation agent in accordance with a scenario of the conversation.

8. The conversation system according to claim 1, wherein the processing circuitry is configured to change the response content of the conversation agent in accordance with a plurality of conversation stages set in advance.

9. The conversation system according to claim 8, wherein the processing circuitry is configured to change a conversation stage, of the plurality of conversation stages, based on line of sight information of the user.

10. The conversation system according to claim 1, wherein the processing circuitry is configured to
generate an image related to conversation content based on at least one of the language information of the user or the non-language information of the user, and
perform the conversation with the user using the image in addition to the conversation agent.

11. The conversation system according to claim 1, wherein the processing circuitry is configured to summarize the conversation based on a conversation log of the conversation.

12. The conversation system according to claim 1,
wherein the conversation is a business negotiation with the user, and
wherein the processing circuitry is configured to propose products and services based on conversation content of the business negotiation.

13. The conversation system according to claim 12, wherein the processing circuitry is configured to present a sales copy of products and services based on the conversation content of the business negotiation.

14. The conversation system according to claim 7, further comprising:
a database to store a past history of the conversation, wherein
the processing circuitry is configured to change the scenario of the conversation based on the past history of the conversation.

15. The conversation system according to claim 1, further comprising:
a database to store a past history of the conversation, wherein
the processing circuitry is configured to generate the verbal response of the conversation agent with reference to the past history of the conversation.

16. The conversation system according to claim 1, wherein the processing circuitry is configured to
acquire the non-language information indicating an attribute of the user from the conversation, and
generate the verbal response or the non-verbal response in accordance with the attribute of the user.

17. A conversation control method executed by a conversation system for performing a conversation with a user using a conversation agent, the conversation control method comprising:
acquiring language information of the user from the conversation;
acquiring non-language information of the user from the conversation;
generating response content including a verbal response and a non-verbal response of the conversation agent, the verbal response being based on the language information of the user and the non-verbal response being based on the non-language information of the user; and
controlling the conversation agent based on the response content.

18. A non-transitory computer-readable medium storing computer executable instructions that, when executed by a conversation system for performing a conversation with a user using a conversation agent, causes the conversation system to perform:
acquiring language information of the user from the conversation;
acquiring non-language information of the user from the conversation;
generating response content including a verbal response and a non-verbal response of the conversation agent, the verbal response being based on the language information of the user and the non-verbal response being based on the non-language information of the user; and
controlling the conversation agent based on the response content.
